(19) United States
(12) Patent Application Publication
(10) Pub. No.: US 2025/0334993 A1
(43) Pub. Date: Oct. 30, 2025

(54) CIRCUIT AND METHOD EMPLOYING TEMPORAL MULTIPLEXING TO PERFORM A MAC OPERATION

(71) Applicant: Taiwan Semiconductor Manufacturing Company, Ltd., Hsinchu (TW)

(72) Inventors: Shinn-Sheng Yu, Hsinchu (TW); Yutong Wu, Hsinchu City (TW)

(21) Appl. No.: 19/264,916

(22) Filed: Jul. 10, 2025

Related U.S. Application Data
(63) Continuation of application No. 18/676,818, filed on May 29, 2024.
(60) Provisional application No. 63/624,350, filed on Jan. 24, 2024.

(51) Int. Cl. G06E 1/04; G06E 3/00

(52) U.S. Cl. CPC G06E 1/045; G06E 3/005

(57) ABSTRACT

Various embodiments of the present disclosure are directed to a photonic circuit for a vector-matrix operation. A source pixel is configured to generate a light beam. An optical fan-out structure is configured to generate a plurality of copies of the light beam. A plurality of modulator pixels are configured to respectively transmit the plurality of copies with individual transmissivities to generate a plurality of transmitted light beams. A plurality of detector pixels are configured to accumulate charge respectively in response to the plurality of transmitted light beams. A controller is configured to control the source pixel and the plurality of modulator pixels to modulate an intensity of the light beam and the individual transmissivities to perform the vector-matrix multiplication operation. The intensity is modulated to temporally encode an input row vector, and the individual transmissivities are modulated to temporally encode corresponding column vectors of a weight matrix.

### REFERENCE TO RELATED APPLICATIONS

This application is a Continuation of U.S. application Ser. No. 18/676,818, filed on May 29, 2024, which claims the benefit of U.S. Provisional Application No. 63/624,350, filed on Jan. 24, 2024. The contents of the above-referenced patent applications are hereby incorporated by reference in their entirety.

### BACKGROUND

Artificial intelligence/machine learning (AI/ML) algorithms have traditionally been implemented by electrical computing, which has seen rapid increases in performance over time thanks to Moore's law. However, AI/ML algorithms have computational demands that are outpacing Moore's law. Further, even if Moore's law were to keep up, the projected power consumption would not be sustainable since power consumption is increasing at a faster rate than computational performance. Therefore, optical computing is receiving increasing attention due to its ability to achieve higher computational performance at lower power consumption.

Deep neural networks (DNNs) correspond to a class of AI/ML algorithms that are increasingly used due to high accuracy modeling compared to competing classes of AI/ML algorithms. DNNs depend heavily on multiply-and-accumulate (MAC) operations, which are computationally intensive. A MAC operation corresponds to vector-matrix multiplication in which an input row vector of size K is multiplied with a weight matrix of size K×N to determine an output row vector of size N. Larger K values generally lead to higher accuracy.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a schematic diagram of some embodiments of a photonic circuit employing temporal multiplexing to perform a multiply-and-accumulate (MAC) operation.

FIG. 2A illustrates a signal timing diagram for some embodiments of a source signal of FIG. 1 and N modulator signals of FIG. 1 during the MAC operation.

FIG. 2B illustrates a timing diagram for some embodiments of charge accumulation at detector pixels of FIG. 1 during the MAC operation.

FIG. 3 illustrates a perspective view of some embodiments of the photonic circuit of FIG. 1 in which Nis 4.

FIGS. 4A-4D illustrate perspective views of some alternative embodiments of the photonic circuit of FIG. 3.

FIG. 5 illustrates a ray diagram of some embodiments of the photonic circuit of FIG. 4D.

FIG. 6 illustrates a schematic diagram of some alternative embodiments of the photonic circuit of FIG. 1 in which an optical fan-out structure is omitted.

FIG. 7 illustrates a perspective view of some embodiments of the photonic circuit of FIG. 6 in which Nis 4.

FIG. 8 illustrates a block diagram of some embodiments of a controller of FIG. 1.

FIGS. 9A and 9B illustrate circuit diagrams for various different embodiments of a detector pixel of FIG. 1.

FIG. 10 illustrates a schematic diagram of some alternative embodiments of the photonic circuit of FIG. 1 in which the photonic circuit employs temporal multiplexing to concurrently perform a plurality of MAC operations.

FIG. 11A illustrates a signal timing diagram for some embodiments of source signals of FIG. 10 and N modulator signals of FIG. 10 during the plurality of MAC operations.

FIG. 11B illustrates a timing diagram for some embodiments of charge accumulation at detector pixels of FIG. 10 during the MAC operation.

FIG. 12 illustrates a cross-sectional view of some embodiments of the photonic circuit of FIG. 10.

FIGS. 13A-13C illustrate cross-sectional views of some alternative embodiments of the photonic circuit of FIG. 12.

FIGS. 14-21 illustrate a series of schematic views of some embodiments of a method for performing a plurality of MAC operations concurrently using temporal multiplexing.

FIG. 22 illustrates a block diagram of some embodiments of the method of FIGS. 14-21.

### DETAILED DESCRIPTION

The present disclosure provides many different embodiments, or examples, for implementing different features of this disclosure. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Photonic multiplication between a first value and a second value may be performed by generating a light beam having an intensity corresponding to the first value and transmitting the light beam through a modulator pixel with a transmissivity corresponding to the second value. The transmitted light beam then has an intensity corresponding to a product of the first and second values. Photonic summation between the first and second values may be performed by generating a pair of light beams with individual intensities corresponding to the first and second values. The pair of light beams may then be focused on a detector pixel, whereat charge corresponding to the summation accumulates and may be measured.

A photonic circuit for optical computing may cascade the photonic multiplication and the photonic summation to perform a multiply-and-accumulate (MAC) operation. The MAC operation comprises multiplication of an input row vector of size K with a weight matrix of size K×N to generate an output row vector of size N. The K values of the input row vector correspond to the K rows of the weight matrix, and each of the K values is multiplied with each of the N values of the weight matrix in a corresponding row of the weight matrix. Therefore, there are K*N photonic multiplications. Further, the products of the photonic multiplications are summed by column of the weight matrix. Therefore, there are N photonic summations.

The K*N photonic multiplications are concurrently performed by an array of K*N source pixels and an array of K*N modulator pixels. The K*N source pixels generate light beams with intensities corresponding to the values of the input row vector. The K*N modulator pixels transmit the light beams with transmissivities corresponding to the values of the weight matrix. Alternatively, the K*N source pixels may be replaced with K source pixels and an optical fan-out structure that creates N copies of each light beam from the K source pixels. The N photonic summations are concurrently performed by an array of N detector pixels and an optical fan-in structure, which focuses the transmitted light beams on the N detector pixels.

It has been appreciated that, so long as K is large (e.g., greater than 10, 100, 1000, or more), power of the light beams may be reduced to low levels (e.g., one photon or some other suitable value) to achieve high power efficiency. At small values of K, a small number of photons impinge on the N detector pixels. As a result, stochastic fluctuations and low signal-to-noise rations (SNRs) at the N detector pixels lead to low accuracy generating the output row vector. However, at large values of K, a large number of photons impinge on the N detector pixels. As a result, stochastic fluctuations cancel each other out and high SNRs at the N detector pixels lead to high accuracy generating the output row vector.

A challenge with the photonic circuit is that all multiplication operations are concurrently performed. As a result, the photonic circuit depends on K*N modulator pixels and, in some embodiments, K*N source pixels. Hence, K is limited by the size of the modulator-pixel array and/or the source-pixel array. Because larger K values generally lead to higher accuracy modeling, this limit on K may limit higher accuracy modeling. Further, because larger K values allow high power efficiency, this limit on K may limit power efficiency.

Various embodiments of the present disclosure pertain to a photonic circuit and a corresponding method employing temporal multiplexing to perform a MAC operation in which an input row vector of size K is multiplied with a weight matrix of size K×N. In some embodiments, a source pixel generates a light beam, which has an intensity modulated according to values of the input row vector. An optical fan-out structure generates N copies of the light beam, and N modulator pixels respectively transmit the N copies to generate N transmitted light beams. The N modulator pixels correspond to column vectors of the weight matrix and, for each of the N modulator pixels, a transmissivity of that modulator pixel is modulated according to values of a corresponding column vector. N detector pixels respectively receive the transmitted light beams and accumulate charge in response to the transmitted light beams.

Because the input row vector is temporally encoded via light-beam intensity, the photonic circuit depends on only a single source pixel to perform the MAC operation. Further, because column vectors of the weight matrix are temporally encoded via modulator-pixel transmissivity, the photonic circuit depends on only N modulator pixels to perform the MAC operation. Hence, K is decoupled from the numbers of source and modulator pixels. Further, K is effectively unlimited, limited only by time, and may hence be large. Because K may be large, high accuracy modeling may be achieved and the source pixel may be driven at low power levels to perform the MAC operation with high power efficiency. Further, because there are N detector pixels and N modulator pixels, an optical fan-in structure may be omitted, and the transmitted light beams may impinge on the N detector pixels orthogonal to light-receiving surfaces of the N detector pixels. As such, accuracy of the MAC operation may be high.

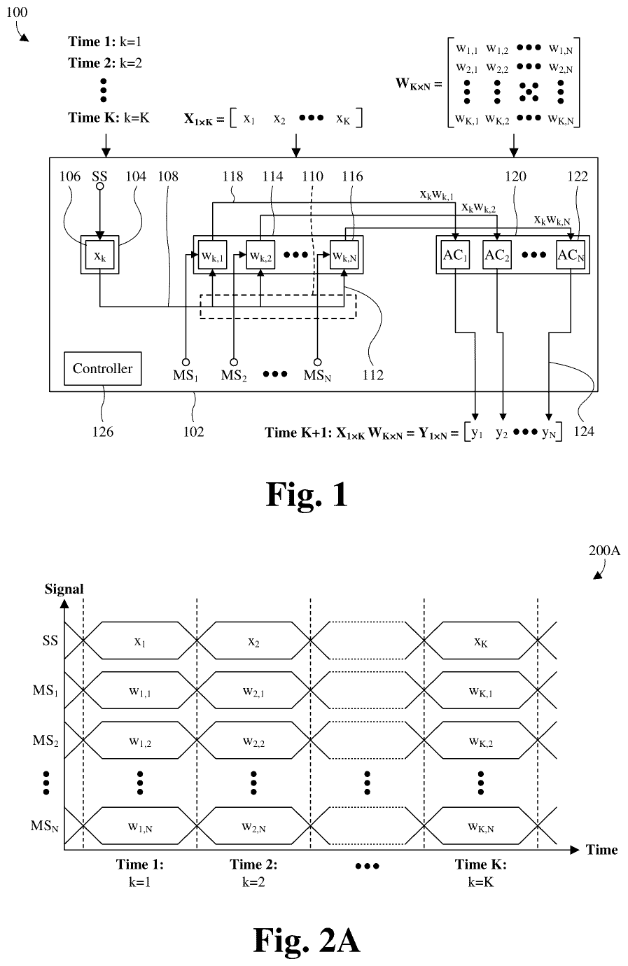

With reference to FIG. 1, a schematic diagram 100 of some embodiments of a photonic circuit 102 employing temporal multiplexing to perform a MAC operation is provided. The photonic circuit 102 is configured to perform the MAC operation over a time period, which is divided into K time segments. Further, the photonic circuit 102 is configured to perform the MAC operation between an input row vector X_{1×K} of size K and a weight matrix W_{K×N} of size K×N (e.g., K rows and N columns) to generate an output row vector Y_{1×N} of size N. K and N are integers greater than one, such as 10, 100, 1000, or some other suitable value.

Elements of the input row vector X_{1×K} are labeled xₖ, elements of the weight matrix W_{K×N} are labeled w_{k,n}, and elements of the output row vector Y_{1×N} are labeled yₙ. k is an integer index from 1 to K. Further, k is an index for the K time segments, for columns of the input row vector X_{1×K}, and for rows in the weight matrix W_{K×N}. n is an integer index from 1 to N. Further, n is an index for columns in the weight matrix W_{K×N} and in the output row vector Y_{1×N}.

A source 104 comprises a source pixel 106, which is configured to generate a light beam 108 with an intensity electrically controlled by a source signal SS. An optical fan-out structure 110 is configured to optically copy the light beam 108 to generate N copies 112 of the light beam 108. By optically copying the light beam 108, rather than using N source pixels, power efficiency is higher than it would otherwise be. A modulator 114 comprises N modulator pixels 116, which have individual transmissivities electrically controlled respectively by N modulator signals MSₙ. Further, the N modulator pixels 116 are configured to respectively transmit the N copies 112 of the light beam 108 with the individual transmissivities to respectively generate N transmitted light beams 118.

A detector 120 comprises N detector pixels 122, which are or comprise individual photodetectors. The N detector pixels 122 are configured to accumulate charge respectively in response to the N transmitted light beams 118 and are labeled with individual accumulated charges ACₙ. Note that charge accumulates at a detector pixel at a rate corresponding to an intensity of a light beam impinging on the detector pixel. The N detector pixels 122 are further configured to convert the individual accumulated charges ACₙ to N readout signals 124, which are electrical signals representative of amounts of the individual accumulated charges ACₙ. As seen hereafter, the N readout signals 124 correspond to values of the output row vector Y_{1×N} after the time period for performing the MAC operation (e.g., at time K+1).

A controller 126 is configured to coordinate the MAC operation. At time 0 (e.g., immediately before the MAC operation), the controller 126 is configured to reset the N detector pixels 122 so the individual accumulated charges ACₙ are zero. From time 1 to time K, the controller 126 is configured to generate the source signal SS and the N modulator signals MSₙ in parallel using temporal multiplexing to perform the MAC operation. At time K+1 (e.g., immediately after the MAC operation), the controller 126 is configured to readout the individual accumulated charges ACₙ to generate the output row vector Y_{1×N}.

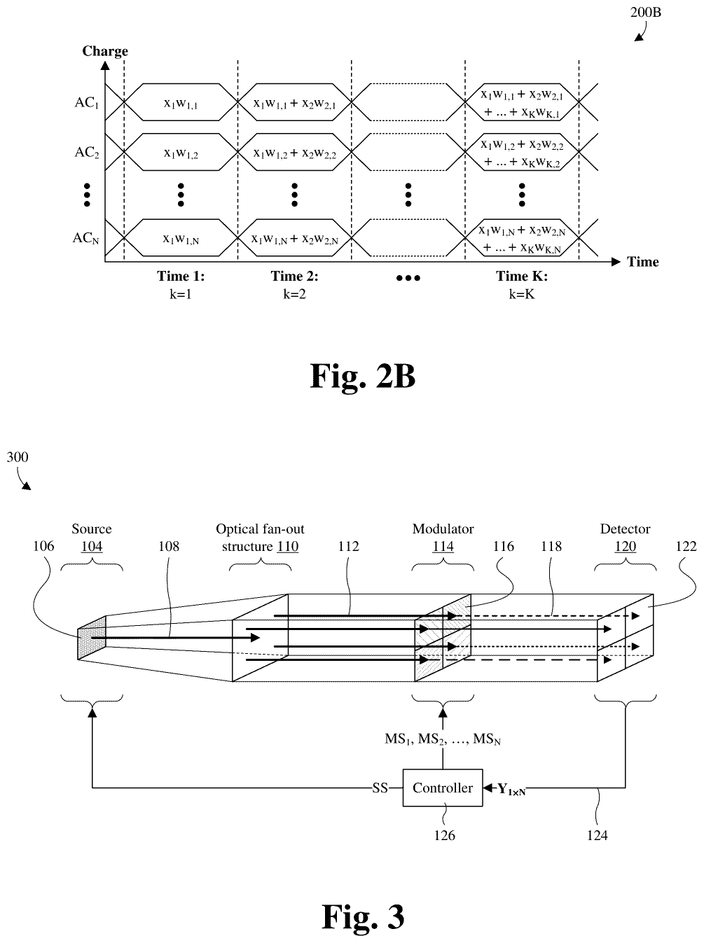

The source signal SS is generated by temporally encoding the input row vector X_{1×K} so as to modulate the intensity of the light beam 108 in accordance with the values of the input row vector X_{1×K}. This is schematically illustrated by labeling the source pixel 106 with an element xx of the input row vector X_{1×K}, where k is an integer index changing over time from 1 to K. Further, FIG. 2A is discussed in detail hereafter and provides a signal timing diagram 200A for some embodiments of the source signal SS from time 1 to time K.

The N modulator signals MSₙ and hence the N modulator pixels 116 correspond to the columns of the weight matrix W_{K×N} and are each generated by temporally encoding a column vector of the weight matrix W_{K×N} at the corresponding column of the weight matrix W_{K×N}. As a result, each of the individual transmissivities of the N modulator pixels 116 is modulated in accordance with the values of the weight matrix W_{K×N} at a corresponding column of the weight matrix W_{K×N}. This is schematically illustrated by labeling the N modulator pixels 116 with elements w_{k,n} of the weight matrix W_{K×N}, where k is an integer index changing over time from 1 to K. Further, FIG. 2A is discussed in detail hereafter and provides a signal timing diagram 200A for some embodiments of the N modulator signals MSₙ from time 1 to time K.

Because the input row vector X_{1×K} is temporally encoded via light-beam intensity, the photonic circuit 102 depends on only a single source pixel to perform the MAC operation. Further, because column vectors of the weight matrix W_{K×N} are temporally encoded via modulator-pixel transmissivity, the photonic circuit 102 depends on only N modulator pixels to perform the MAC operation. Hence, K is decoupled from the numbers of source and modulator pixels. Further, K is effectively unlimited, limited only by time, and may hence be large.

Because K may be large, high accuracy modeling may be achieved when the photonic circuit 102 is employed to perform MAC operations for deep neural network (DNN) algorithms or other suitable artificial intelligence/machine learning (AI/ML) algorithms. Further, because K may be large, the source pixel 106 may be driven at a low power level to perform the MAC operation with high power efficiency. The low power level may, for example, be a power level of less than 10 photons, 1 photon, less than 1 photon (on average), or some other suitable level per photonic multiplication of the MAC operation.

Transmitting a light beam through a modulator pixel with a transmissivity yields a transmitted light beam, which has an intensity corresponding to a product of photonic multiplication between an intensity of the light beam and the transmissivity. Therefore, because the input row vector X_{1×K} is encoded via the light-beam intensity, and because the weight matrix W_{K×N} is encoded via the modulator-pixel transmissivity, each of the N transmitted light beams 118 has an intensity corresponding to a product of photonic multiplication between a value xₖ of the input row vector X_{1×K} and a value w_{k,n} of the weight matrix W_{K×N}.

Because the intensity of the light beam 108 and the individual transmissivities of the N modulator pixels 116 are modulated, photonic multiplication is performed over time and the N transmitted light beams 118 have individual intensities that are modulated. At time 1, k=1 and hence photonic multiplication is performed between the first element x₁ of the input row vector X_{1×K} and the first row of the weight matrix W_{K×N}. At time 2, k=2 and hence photonic multiplication is performed between the second element x₂ of the input row vector X_{1×K} and the second row of the weight matrix W_{K×N}. This continues until time K. At time K, k=K and hence photonic multiplication is performed between the last or Kth element x_{K} of the input row vector X_{1×K} and the last or Kth row of the weight matrix W_{K×N}.

Because the individual transmissivities of the N modulator pixels 116 are modulated according to corresponding columns of the weight matrix W_{K×N}, the N transmitted light beams 118 have individual intensities temporally encoding the products of photonic multiplication within corresponding columns of the weight matrix W_{K×N}. For example, at time 1, k=1 and hence a first transmitted light beam has an intensity corresponding to a product of photonic multiplication between a first element x₁ of the input row vector X_{1×K} and a first element w_{1,1} in a first column of the weight matrix W_{K×N}. At time 2, k=2 and hence the first transmitted light beam has an intensity corresponding to a product of photonic multiplication between a second element x₂ of the input row vector X_{1×K} and a second element w_{2,1} in the first column. This continues until time K. At time K, k=K and hence the first transmitted light beam has an intensity corresponding to a product of photonic multiplication between a last or Kth element x_{K} of the input row vector X_{1×K} and a last or Kth element w_{K,1} in the first column.

Directing a plurality of light beams on a detector pixel concurrently or in sequence yields an accumulation of charge, which represents a photonic summation of individual intensities of the plurality of light beams. Therefore, because the N detector pixels 122 correspond to the N transmitted light beams 118, which have individual intensities temporally encoding the products of photonic multiplication within corresponding columns of the weight matrix W_{K×N}, the individual accumulated charges ACₙ represent photonic summations of the products of photonic multiplications within corresponding columns.

Because the photonic multiplications occur over time, the photonic summations also occur over time. At time 1, k=1 and hence the individual accumulated charges ACₙ correspond to summations between accumulated charges from time 0 and accumulated charges for products of photonic multiplication at time 1. Note that the controller 126 resets the N detector pixels 122 before the MAC operation, such that the accumulated charges from time 0 are zero. At time 2, k=2 and hence the individual accumulated charges ACₙ correspond to summations between accumulated charges from times 0 and 1 and accumulated charges for products of photonic multiplication at time 2. This continues until time K. At time K, k=K and hence the individual accumulated charges ACₙ correspond to summations between accumulated charges from times 0 to K−1 and accumulated charges for products of photonic multiplication at time K. FIG. 2B is discussed in detail hereafter and provides a timing diagram 200B for some embodiments of the individual accumulated charges ACₙ from time 1 to time K.

Because photonic summation is performed over time, and there may be a one-to-one correspondence between the N modulator pixels 116 and the N detector pixels 122, an optical fan-in structure may be omitted. Further, the N transmitted light beams 118 may impinge on the N detector pixels 122 orthogonal to light-receiving surfaces of the N detector pixels 122. This may increase the accuracy of the MAC operation.

After the MAC operation (e.g., at time K+1), the individual accumulated charges ACₙ may be converted to values of the output row vector Y_{1×N}. For example, the controller 126 may control the N detector pixels 122 to convert the individual accumulated charges ACₙ respectively to the N readout signals 124 and may then translate values of the N readout signals 124 respectively to values of the output row vector Y_{1×N} using a function f1(z). The N readout signals 124 may, for example, represent amounts of the accumulated charges ACₙ by voltage, current, or the like, such that the values of the N readout signals 124 may correspond to voltage, current, or the like. Further, the function f1(z) may, for example, relate a value Zn of a readout signal to a value yₙ of the output row vector Y_{1×N}.

In some embodiments, the source pixel 106 is or comprises a light-emitting diode (LED), a vertical-cavity surface-emitting laser (VCSEL), or the like. The LED may, for example, be or comprise an organic light-emitting diode (OLED), a mini LED, a micro LED, or some other suitable type of LED. The source 104 may, for example, be integrated into or otherwise be an integrated circuit (IC) chip or die.

In some embodiments, the modulator 114 is or comprises a spatial light modulator (SLM) or the like. Further, in some embodiments, the modulator 114 is integrated into or otherwise is an IC chip or die. Further, in some embodiments, the modulator 114 may also be known as an amplitude modulator or the like.

In some embodiments, the optical fan-out structure 110 is or comprises a 4f optical system and a diffractive optical element (DOE). The 4f optical system comprises a first lens and a second lens. Further, the DOE is at a back focal plane of the first lens and a front focal plane of the second lens, which are the same and which may, for example, be known as a Fourier plane, a pupil plane, or the like. In other embodiments, the optical fan-out structure 110 is or comprises a cylindrical lens, a microlens array, or the like.

In some embodiments, the detector 120 is or comprises a complementary metal-oxide-semiconductor (CMOS) or the like. In some embodiments, the detector 120 is integrated into or otherwise is an IC chip or die. In some embodiments, the N detector pixels 122 comprise individual photodetectors for charge accumulation. In some of such embodiments, the N detector pixels 122 further comprise individual capacitors electrically coupled respectively with the individual photodetectors for additional charge accumulation. For example, a capacitor may integrate photocurrent generated by a corresponding photodetector. In other of such embodiments, the N detector pixels 122 are devoid of the individual capacitors. In some embodiments, the N detector pixels 122 comprise individual multi-pixel photon counters (MPPCs) and individual capacitors electrically coupled respectively to the MPPCs. In some embodiments, the N detector pixels 122 are or comprise active-pixel sensors (APSs), such as four transistor (4T) APSs or some other suitable type of APS.

In some embodiments, the controller 126 modulates the source signal SS and the N modulator signals MSₙ at a modulation frequency, which is 1 megahertz to 1 gigahertz, 1 gigahertz to 100 gigahertz, or some other suitable value. These high frequencies may allow the MAC operation to be performed at high speed and with a large value of K. For example, supposing the modulation frequency is 1 gigahertz, the MAC operation may be performed with K=8,294,400 in about 0.008 seconds. In some embodiments, the K time segments are equal in duration. Further, in some embodiments, one, some, or all of the K time segments each has a duration equal to 1/f, where f is the modulation frequency.

In some embodiments, the controller 126 is or comprises a microcontroller, a system on a chip (SoC), electrical circuitry, additional electrical devices, or any combination of the foregoing. In some embodiments, the controller 126 comprises one or more analog-to-digital converters (ADCs) and one or more digital-to-analog converters (DACs). The ADC(s) may, for example, be used to read the N readout signals 124 from the N detector pixels 122, whereas the DAC(s) may, for example, be used to generate the source signal SS and the N modulator signals MSₙ. In first embodiments, the controller 126 may comprise a memory and a processor configured to execute instructions on the memory to coordinate the MAC operation. In second embodiments, the controller 126 may comprise an application-specific integrated circuit (ASIC), a field-programmable gate array (FGPA), or the like to coordinate the MAC operation. In the first embodiments, the second embodiments, or other embodiments, the coordination may, for example, involve control over the ADC(s) and/or the DAC(s).

In some embodiments, such as where the MAC operation is employed for DNN algorithms, the input row vector X_{1×K} may also be known as an input activation or the like. Further, in at least some of these embodiments, elements of the input row vector X_{1×K} may also be known as input neurons or the like, whereas elements of the output row vector Y_{1×N} may also be known as output neurons or the like.

With reference to FIG. 2A, a signal timing diagram 200A for some embodiments of the source signal SS of FIG. 1 and the N modulator signals MSₙ of FIG. 1 during a MAC operation is provided. The horizontal axis corresponds to time, and the vertical axis corresponds to signal. The signals may, for example, be modulated by current, voltage, or the like.

Focusing on the source signal SS, the source signal SS is modulated to modulate an intensity of the light beam 108 in accordance with the input row vector X_{1×K}. At time 1, k=1 and hence the source signal SS and the intensity correspond to the first element of the input row vector X_{1×K} (e.g., x₁). At time 2, k=2 and hence the source signal SS and the intensity correspond to the second element of the input row vector X_{1×K} (e.g., x₂). This continues until time K. At time K, k=K and hence the source signal SS and the intensity correspond to the last or Kth element of the input row vector X_{1×K} (e.g., x_{K}).

In some embodiments, a value αₖ of the source signal SS at time k is related to a value xₖ of the input row vector X_{1×K} at time k by a discrete function f2(x). The value αₖ of the source signal SS may, for example, correspond to a current value, a voltage value, or the like. The discrete function f2(x) may, for example, be used by the controller 126 to translate the value xₖ of the input row vector X_{1×K} to the value αₖ of the source signal SS so the intensity of the light beam 108 encodes the value xₖ of the input row vector X_{1×K}.

Focusing on the N modulator signals MSₙ, the N modulator signals MSₙ are modulated to modulate the individual transmissivities of the N modulator pixels 116 in accordance with corresponding columns of the weight matrix W_{K×N}. At time 1, k=1 and hence the N modulator signals MSₙ and the individual transmissivities correspond to the first row of the weight matrix W_{K×N} (e.g., [w_{1,1} w_{1,2} . . . w_{1,N}]). At time 2, k=2 and hence the N modulator signals MSₙ and the individual transmissivities correspond to the second row of the weight matrix W_{K×N} (e.g., [w_{2,1} w_{2,2} . . . w_{2,N}]). This continues until time K. At time K, k=K and hence the N modulator signals MSₙ and the individual transmissivities correspond to the last or Kth row of the weight matrix W_{K×N} (e.g., [w_{K,1} w_{K,2} . . . w_{K,N}]).

In some embodiments, a value λ_{k,n} of a modulator signal MSₙ at time k is related to a value w_{k,n} of the weight matrix W_{K×N} at time k by a discrete function f3(w). The value λ_{k,n} of the modulator signal MSₙ may, for example, be a current value, a voltage value, or the like. The discrete function f3(x) may, for example, be used by the controller 126 to translate the value w_{k,n} of the weight matrix W_{K×N} to the value λ_{k,n} of a modulator signal MSₙ so a corresponding modulator pixel has a transmissivity that encodes the value w_{k,n} of the weight matrix W_{K×N}.

With reference to FIG. 2B, a timing diagram 200B for some embodiments of charge accumulation at the detector pixels 114 of FIG. 1 during the MAC operation is provided. The horizontal axis corresponds to time, and the vertical axis corresponds to the individual accumulated charges ACₙ of the detector pixels 114.

At time 1, k=1 and hence photonic multiplication is performed between the first element of the input row vector X_{1×K} (e.g., x₁) and the first row of the weight matrix W_{K×N} (e.g., [w_{1,1} w_{1,2} . . . w_{1,N}]). See, for example, FIG. 2A. Because the N transmitted light beams 118 encode products of this multiplication and impinge respectively on the N detector pixels 122, the N detector pixels 122 accumulate charge proportional respectively to the products. Further, because the N detector pixels 122 are reset before the MAC operation, the only accumulated charge at the N detector pixels 122 is from the photonic multiplication.

At time 2, k=2 and hence photonic multiplication is performed between the second element of the input row vector X_{1×K} (e.g., x₂) and the second row of the weight matrix W_{K×N} (e.g., [w_{2,1} w_{2,2} . . . w_{2,N}]). See, for example, FIG. 2A. Because the N transmitted light beams 118 encode products of this multiplication and impinge respectively on the N detector pixels 122, the N detector pixels 122 further accumulate charge proportional respectively to the products. Hence, the individual accumulated charges ACₙ of the N detector pixels 122 correspond to summations of accumulated charge from previous photonic multiplication with accumulated charge for the current photonic multiplication.

The above sequence continues until time K. At time K, k=K and hence photonic multiplication is performed between the last or Kth element of the input row vector X_{1×K} (e.g., x_{K}) and the last or Kth row of the weight matrix W_{K×N} (e.g., [w_{K,1} w_{K,2} . . . w_{K,N}]). See, for example, FIG. 2A. Because the N transmitted light beams 118 encode products of this multiplication and impinge respectively on the N detector pixels 122, the N detector pixels 122 further accumulate charge proportional respectively to the products. Hence, the individual accumulated charges ACₙ of the N detector pixels 122 correspond to summations of accumulated charge from previous photonic multiplication with accumulated charge for the current photonic multiplication. This may be summarized as ACₙ=Σᵢ₌₁^{k} xᵢw_{i,n}.

With reference to FIG. 3, a perspective view 300 of some embodiments of the photonic circuit 102 of FIG. 1 is provided in which Nis 4. The source pixel 106 is configured to generate the light beam 108, which passes to the optical fan-out structure 110. The optical fan-out structure 110 is configured to generate the N copies 112 of the light beam 108, which pass respectively through the N modulator pixels 116 to respectively generate the N transmitted light beams 118. The N detector pixels 122 respectively receive the N transmitted light beams 118 orthogonal to light receiving surfaces of the N detector pixels 122.

Because the N transmitted light beams 118 impinge on the light receiving surfaces orthogonal to the surfaces, the N detector pixels 122 more accurately measure intensities of the N transmitted light beams 118. Accumulated charges at the N detector pixels 122 more accurately reflect the intensities of the N transmitted light beams 118.

The controller 126 is configured to coordinate a MAC operation between the input row vector X_{1×K} (see, e.g., FIG. 1) and the weight matrix W_{K×N} (see, e.g., FIG. 1). At time 0, the controller 126 is configured to reset accumulated charge at the N detector pixels 122. From time 1 to time K, the controller 126 is configured to modulate the source signal SS and the modulator signals MSₙ in accordance with the input row vector X_{1×K} and the weight matrix W_{K×N} to perform the MAC operation. At time K+1, the controller 126 is configured to generate the output row vector Y_{1×N} from charge that accumulated at the N detector pixels 106.

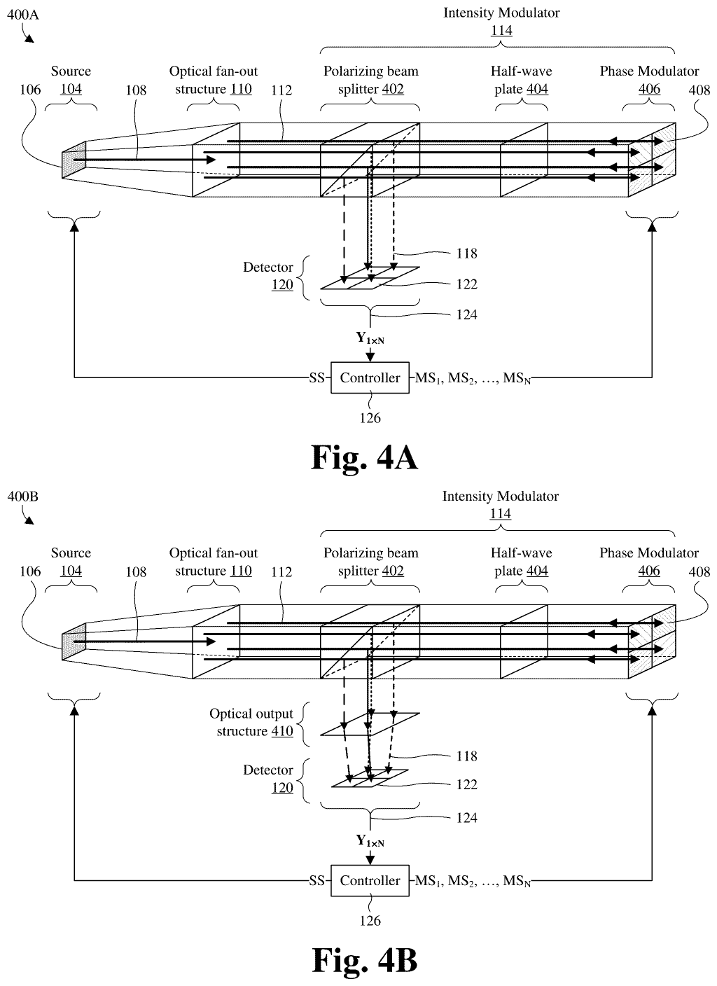

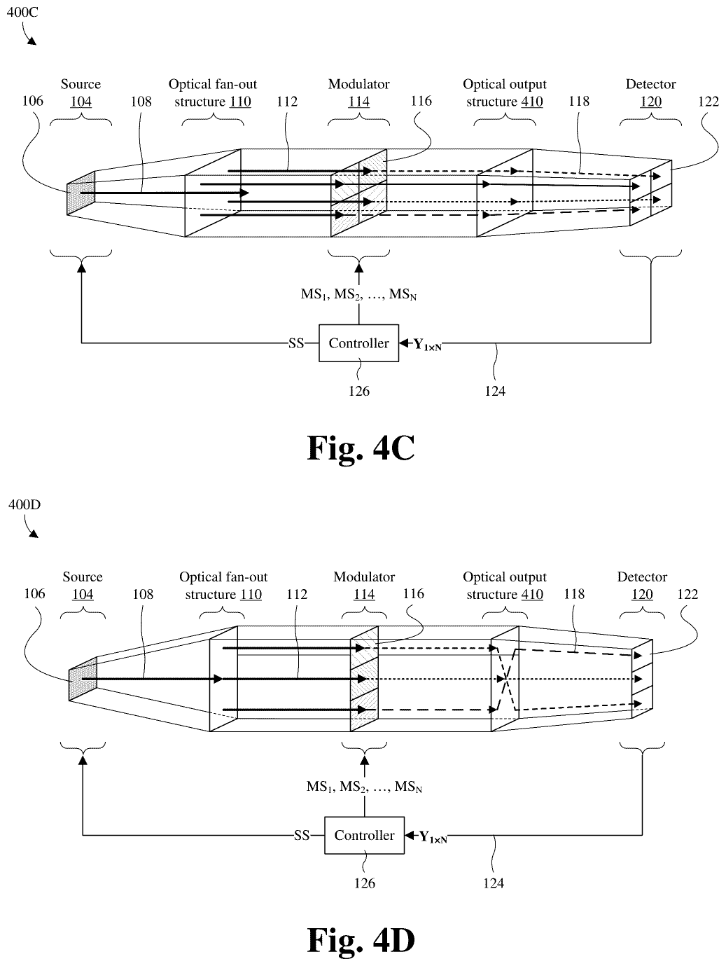

With reference to FIG. 4A, a perspective view 400A of some alternative embodiments of the photonic circuit of FIG. 3 is provided in which the modulator 114 (also known as an intensity modulator) has a composite structure that comprises a polarizing beam splitter (PBS) 402, a half-wave plate (HWP) 404, and a phase modulator 406.

The optical fan-out structure 110 is configured to generate the N copies 112, which pass to a source-side of the PBS 402. The source-side refers to a side of the PBS 402 facing the source 104. The PBS 402 is configured to transmit horizontally polarized light and to reflect vertically polarized light. Further, the PBS 402 is configured to convert the polarization state of light to intensity to generate the N transmitted light beams 118.

The N copies 112 of the light beam 108 enter the source-side of the PBS 402 in a horizontally polarized state. This may be from, for example, the optical fan-out structure 110, an input filter on the source-side of the PBS 402, or some other suitable optical structure. Because of the horizontal polarization, the N copies 112 pass through the PBS 402 and exit a phase-modulator-side of the PBS 402. The phase-modulator-side refers to a side of the PBS 402 facing the phase modulator 406. Further, the N copies 112 pass to the HWP 404.

The HWP 404 is configured to transmit the N copies 112 of the light beam 108 while rotationally shifting the polarization of the N copies 112. Further, the HWP 404 has an angular offset between its fast axis and an extraordinary axis of the phase modulator 406. The angular offset may be shifted to vary the polarization of the N copies 112. This shift in polarization may reduce an average intensity of the N transmitted light beams 118. Further, the closer the angular offset is to 22.5 degrees, the greater the average intensity.

After passing through the HWP 404, the N copies 112 of the light beam 108 impinge respectively on N modulator pixels 408 of the phase modulator 406, which are configured to respectively reflect the N copies 112. For each of the N copies 112, the reflection introduces a phase difference between extraordinary light of the copy and ordinary light of the copy and further introduces a polarization shift, such at that the extraordinary light and the ordinary light have polarizations orthogonal to each other. Further, the phase difference varies depending on a refractive index of a corresponding modulator pixel, which may be electrically controlled by a corresponding one of the N modulator signals MSₙ.

The reflected light beams pass through the HWP 404 and enter the phase-modulator-side of the PBS 402. Thereat, the PBS 402 is configured to reflect only vertically-polarized components of the reflected light beams to generate the N transmitted light beams 118. By reflecting only vertically-polarized components, the PBS 402 converts the polarization states of the reflected light beams to intensity. Hence, phase modulation at the phase modulator 406 may be employed to intensity modulate the N copies 112 of the light beam 108.

During the MAC operation, the N modulator signals MSₙ are generated to modulate the individual refractive indexes of the N modulator pixels 408 so the N copies 112 are transmitted through the composite structure of the modulator 114 with individual transmissivities that temporally encode values of the weight matrix W_{K×N}. Further, rather than values of the modulator signals MSₙ corresponding directly to transmissivity, the values correspond to refractive index and/or phase difference, which indirectly corresponds to transmissivity.

With reference to FIG. 4B, a perspective view 400B of some alternative embodiments of the photonic circuit of FIG. 4A is provided in which the photonic circuit 102 further comprises an optical output structure 410. The optical output structure 410 is between an output of the PBS 402 and the detector 120. The optical output structure 410 may, for example, be employed to focus the N transmitted light beams 118 respectively on the N detector pixels 122. However, other suitable optical functions to facilitate and/or enhance detection of the N transmitted light beams 118 at the detector 120 are amenable.

In some embodiments, the optical output structure 410 is or comprises a 4f optical system. The 4f optical system comprises a first lens and a second lens. In other embodiments, the optical output structure 410 is or comprises a microlens array or the like.

With reference to FIG. 4C, a perspective view 400C of some alternative embodiments of the photonic circuit of FIG. 3 is provided in which the photonic circuit 102 further comprises the optical output structure 410. The optical output structure 410 is configured to focus the N transmitted light beams 118 respectively on the N detector pixels 122. As above, other suitable optical functions to facilitate and/or enhance detection of the N transmitted light beams 118 at the detector 120 are additionally or alternatively amenable. The optical output structure 410 may, for example, find applications in which the N detector pixels 122 are a different size (e.g., smaller) than the N modulator pixels 116.

With reference to FIG. 4D, a perspective view 400D of some alternative embodiments of the photonic circuit of FIG. 4C is provided in which N is three, instead of four. As such, the modulator 114 has three modulator pixels 116 and the detector 120 has three detector pixels 122. Further, in contrast with FIG. 4C, the three modulator pixels 116 are vertically oriented, the three detector pixels 122 are vertically oriented, and two of the N transmitted light beams 118 cross each other at the optical output structure 410.

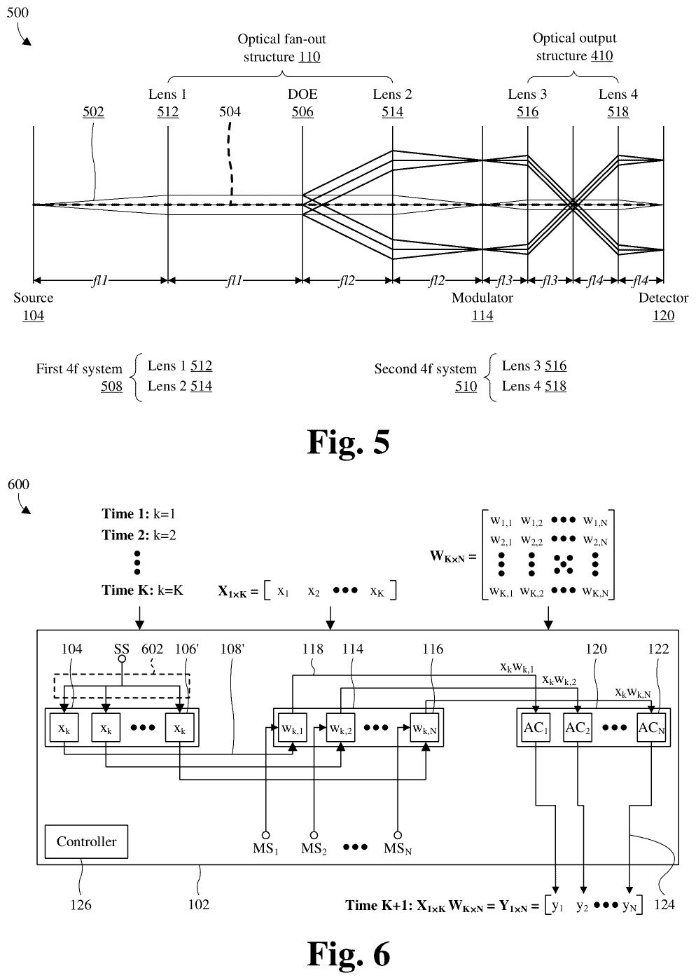

With reference to FIG. 5, a ray diagram 500 of some embodiments of the photonic circuit of FIG. 4D is provided in which light rays 502 travel from the source 104 to the detector 120 (e.g., from left to right). Further, the ray diagram 500 illustrates additional structure of the optical fan-out structure 110 and the optical output structure 410. The optical fan-out structure 110 and the optical output structure 410 share a common optical axis 504, and the source 104, the modulator 114, and the detector 120 overlap with the common optical axis 504. The optical fan-out structure 110 comprises a DOE 506 and a first 4f system 508. The optical output structure 410 is or comprises a second 4f system 510.

The first 4f system 508 comprises a first lens 512 and a second lens 514. The source 104 is at a front focal plane of the first lens 512, which is separated from the first lens 512 by a first focal length f11. The DOE 506 is at a back focal plane of the first lens 512 and a front focal plane of the second lens 514, which are the same and which may, for example, be known as a Fourier plane. The back focal plane of the first lens 512 is separated from the first lens 512 by the first focal length f11, whereas the front focal plane of the second lens 514 is separated from the second lens 514 by a second focal length f12. The second focal length f12 may, for example, be less than the first focal length f11. The modulator 114 is at a back focal plane of the second lens 514, which is separated from the second lens 514 by the second focal length f12.

Between the source 104 and the first lens 512, light rays are spherical divergent rays. Between the first lens 512 and the DOE 506, light rays are parallel rays. Hence, the first lens 512 is configured to collimate light. The DOE 506 is configured to generate copies of light rays from the first lens 512. Between the DOE 506 and the second lens 514, light rays are parallel rays. Between the second lens 514 and the modulator 114, light rays are spherical convergent rays. Hence, the second lens 514 is configured to focus light.

The second 4f system 510 comprises a third lens 516 and a fourth lens 518. The modulator 114 is at a front focal plane of the third lens 516, which is separated from the third lens 516 by a third focal length f13 and which is the same as the back focal plane of the second lens 514. The third focal length f13 may, for example, be less than the first or second focal length f11, f12. A back focal plane of the third lens 516 overlaps with a front focal plane of the fourth lens 518. The back focal plane of the third lens 516 is separated from the third lens 516 by the third focal length f13, and the front focal plane of the fourth lens 518 is separated from the fourth lens 518 by a fourth focal length f14. The fourth focal length f14 may, for example, be the same as or less than the third focal length f13. The detector 120 is at the back focal plane of the fourth lens 518, which is separated from the fourth lens 4 by the fourth focal length f14.

Between the modulator 114 and the third lens 516, light rays are spherical divergent rays. Between the third lens 516 and the fourth lens 518, light rays are parallel rays. Hence, the third lens 516 is configured to collimate light. Between the fourth lens 518 and the detector 120, light rays are converging spherical rays. Hence, the second lens 514 is configured to focus light.

In some embodiments, the first, second, third, and fourth lenses 512-518 (collectively the lenses) are concave lenses. In other embodiments, other suitable lens types are amenable for any one or more of the lenses. In some embodiments, the DOE 506 has a periodic pattern that diffracts incoming light rays into various diffraction orders to generate copies of the incoming light rays. Further, in some embodiments, the DOE 506 is or comprises a diffraction grating and/or the periodic pattern is with regard to slits through the DOE 506.

With reference to FIG. 6, a schematic diagram 600 of some alternative embodiments of the photonic circuit 102 of FIG. 1 is provided in which the optical fan-out structure 110 is omitted. Instead, the source 104 comprises M source pixels 106′.

The M source pixels 106′ are respectively configured to generate M light beams 108′, which have individual intensities that are controlled in accordance with the source signal SS. Further, the M source pixels 106′ each receive the source signal SS via an electrical fan-out structure 602, which is configured to generate N copies of the source signal SS. The N modulator pixels 116 respectively transmit the M light beams 108′ with corresponding transmissivities to respectively generate the N transmitted light beams 118.

Compared to the photonic circuit 102 of FIG. 1, a MAC operation is performed the same, except the M light beams 108′ take the place of the N copies 112 of the light beam 108 in FIG. 1. The signal timing diagram 200A of FIG. 2A is still representative of the source signal SS and the N modulator signals MSₙ. Further, the timing diagram 200B of FIG. 2B is still representative of charge accumulation at the N detector pixels 122.

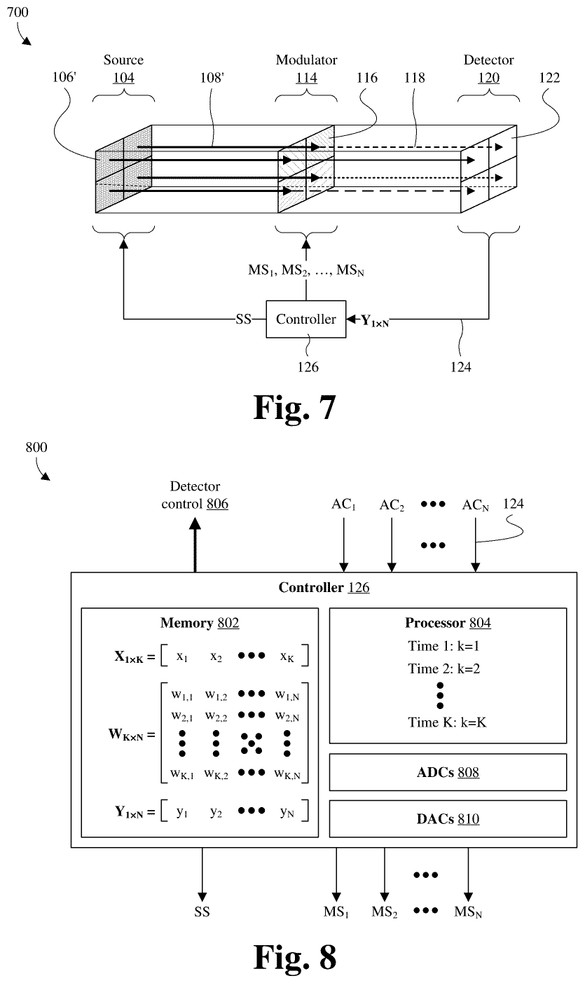

With reference to FIG. 7, a perspective view 700 of some embodiments of the photonic circuit 102 of FIG. 6 is provided. The perspective view 700 is similar to that of FIG. 3, except that the optical fan-out structure 110 is omitted. In alternative embodiments, the modulator 114 may be replaced with embodiments as in FIG. 4A, and/or the photonic circuit may comprise the optical output structure 410 as in FIGS. 4B and 4C and/or as in FIG. 5.

With reference to FIG. 8, a block diagram 800 of some embodiments of the controller 126 of FIG. 1 is provided in which the controller 126 is shown with additional detail. The controller 126 comprises a memory 802 and processor 804.

The memory 802 stores the input row vector X_{1×K} and the weight matrix W_{K×N} for a MAC operation and, after performing the MAC operation, stores the output row vector Y_{1×N} that results from the MAC operation. Further, in some embodiments, the memory 802 may store processor executable instructions for coordinating the MAC operation. The memory 802 may, for example, be or comprise volatile or non-volatile and may, for example, be flash memory, dynamic random-access memory (DRAM), static random-access memory (SRAM), or the like.

The processor 804 is configured to coordinate the MAC operation. For example, at time 0, the processor 804 may modulate a plurality of detector control signals 806 to reset the individual accumulated charges ACₙ of the N detector pixels 122. At times 1 to K, the processor 804 may generate the source signal SS and the N modulator signals MSₙ to perform the MAC operation. FIG. 2A provides an example of these signals. At time K+1, the processor 804 may modulate the plurality of detector control signals 806 to cause the N detector pixels 122 to convert the individual accumulated charges ACₙ to the N readout signals 124. Further, the processor 804 may read parameters (e.g., voltage, current, etc.) of the N readout signals 124 to generate the output row vector Y_{1×N}, which may then be stored in the memory 802.

In some embodiments, the processor 804 is or comprises a microprocessor, electrical circuitry, the like, or any combination of the foregoing. In some embodiments, the controller 126 comprises a plurality of ADCs 808 and a plurality of DACs 810 that are controlled by the processor 804 to perform the MAC operation. For example, the processor 804 may control the plurality of ADCs 808 to read the parameters of the N electrical signals. As another example, the processor 804 may control the plurality of DACs 810 to generate the plurality of detector control signals 806, the source signal SS, and the N modulator signals MSₙ.

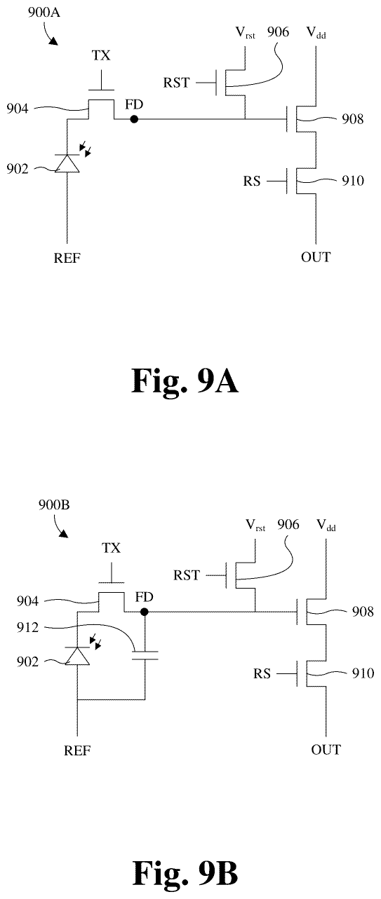

With reference to FIG. 9A, a circuit diagram 900A of some embodiments of a detector pixel, which is representative of each of the N detector pixels 122 of FIG. 1, is provided. The detector pixel may, for example, correspond to a 4T APS or the like.

A photodetector 902 is electrically coupled from a reference terminal REF (e.g., ground) to a transfer transistor 904. The photodetector 902 is configured to receive incident light and to accumulate charge in response to the incident light. The incident light may, for example, correspond to one of the N transmitted light beams 118 of FIG. 1. The photodetector 902 may, for example, be a pinned photodiode (PPD), a single-photon avalanche diode (SPAD), an avalanche photodiode, or some other suitable type of photodetector.

The transfer transistor 904 is electrically coupled from a cathode of the photodetector 902 to a floating diffusion node FD. Further, the transfer transistor 904 is controlled by a transfer control signal TX to selectively transfer charge that accumulates in the photodetector 902 to the floating diffusion node FD. The transfer control signal TX may, for example, correspond to one of the plurality of detector control signals 806 in FIG. 8.

A reset transistor 906 is electrically coupled from the floating diffusion node FD to a reset-voltage node Vᵣₛₜ. Further, the reset transistor 906 is controlled by a reset control signal RST to selectively clear charge that has accumulated at the photodetector 902 and that has been transferred to the floating diffusion node FD. The reset control signal RST may, for example, correspond to one of the plurality of detector control signals 806 in FIG. 8.

A source-follower transistor 908 and a row-select transistor 910 are electrically coupled in series from a supply-voltage node V_{dd} to an output node OUT. The source-follower transistor 908 is gated by charge at the floating diffusion node FD and is configured to convert the charge into a readout signal (e.g., one of the N readout signals 124 of FIG. 1). For example, source-follower transistor 908 may generate the readout signal with a voltage proportional to the amount of charge at the floating diffusion node FD.

The row-select transistor 910 is controlled by a row-select control signal RS to selectively pass the readout signal from the source-follower transistor 908 to the output node OUT. The row-select control signal RS may, for example, correspond to one of the plurality of detector control signals 806 in FIG. 8. To the extent that the detector pixel repeats in a plurality of rows and a plurality of columns, detector-pixel instances within a column may be readout through a common conductive line, which is electrically coupled to the individual output nodes OUT of the detector-pixel instances in the column. The row-select transistor 910 allows only one detector-pixel instance in the column to be selected for readout at a given time.

To perform a MAC operation using the detector pixel, the controller 126 of FIGS. 1 and 8 may initially (e.g., at time 0) reset the charge at the photodetector 902 and the floating diffusion node FD using the reset transistor 906 and the transfer transistor 904. For example, the controller 126 may turn the reset transistor 906 and the transfer transistor 904 to ON states to electrically couple the photodetector 902 and the floating diffusion node FD to the reset-voltage node Vᵣₛₜ. Thereafter (e.g., at times 1 to K), the controller 126 may allow charge to accumulate in the photodetector 902 by leaving the transfer transistor 904 in an OFF state.

After the accumulation period (e.g., at time K+1), the controller 126 may readout the accumulated charge. For example, the controller 126 may control the transfer transistor 904 to transfer the accumulated charge to the floating diffusion node FD. This yields a readout signal at an output of the source-follower transistor 908, which has a voltage that is proportional to the amount of accumulated charge. The controller 126 further controls the row-select transistor 910 to pass the readout signal to the output node OUT, whereby the controller 126 reads the readout signal to determine an element of an output row vector.

With reference to FIG. 9B, a circuit diagram 900B of some alternative embodiments of a detector pixel of FIG. 9A is provided in which the detector pixel further comprises a capacitor 912 for charge accumulation. The capacitor 912 is electrically coupled from the floating diffusion node FD to the reference node REF and is configured to integrate charge that accumulates over time during a MAC operation.

To perform a MAC operation using the detector pixel, the controller 126 of FIGS. 1 and 8 may initially (e.g., at time 0) reset the charge at the photodetector 902, the floating diffusion node FD, and the capacitor 912 using the reset transistor 906 and the transfer transistor 904. For example, the controller 126 may turn the reset transistor 906 and the transfer transistor 904 to ON states to electrically couple the photodetector 902, the floating diffusion node FD, and the capacitor 912 to the reset-voltage node Vᵣₛₜ. Thereafter (e.g., at times 1 to K), at each of the K time segments, the controller 126 may allow charge to accumulate in the photodetector 902 by leaving the transfer transistor 904 in an OFF state and may then transfer the accumulated charge to the capacitor 912 by changing the transfer transistor 904 to the ON state.

After the accumulation period (e.g., at time K+1), the controller 126 may control the row-select transistor 910 to pass a readout signal generated by the source-follower transistor 908 to the output node OUT. The controller 126 may then measure the readout signal to determine an element of an output row vector. The source-follower transistor 908 may generate the readout signal in accordance with charge transferred to and accumulated at the capacitor 912.

The capacitor 912 may, for example, be a metal-insulator-metal (MIM) capacitor, a metal-oxide-semiconductor (MOS) capacitor, or some other suitable type of capacitor. Further, in some embodiments, the floating diffusion node FD intrinsically forms a parasitic capacitor, which is electrically coupled in parallel with the capacitor 912. For example, the floating diffusion node FD may correspond to an N-type doped region of a substrate, which is inset into a P-type doped region of the substrate. As such, the parasitic capacitor forms at a PN junction between the N-type doped region and the P-type doped region.

While FIGS. 8, 9A, and 9B are described with regard to the photonic circuit of FIG. 1, it is to be appreciated that FIGS. 8, 9A, and 9B are applicable to any of FIGS. 3, 4A-4D, 6, and 7. For example, the controller 126 in any of FIGS. 3, 4A-4D, 6, and 7 may be as in FIG. 8. Further, each of the detector pixels 122 in any of FIGS. 3, 4A-4D, 6, and 7 may be as in FIG. 9A or 9B.

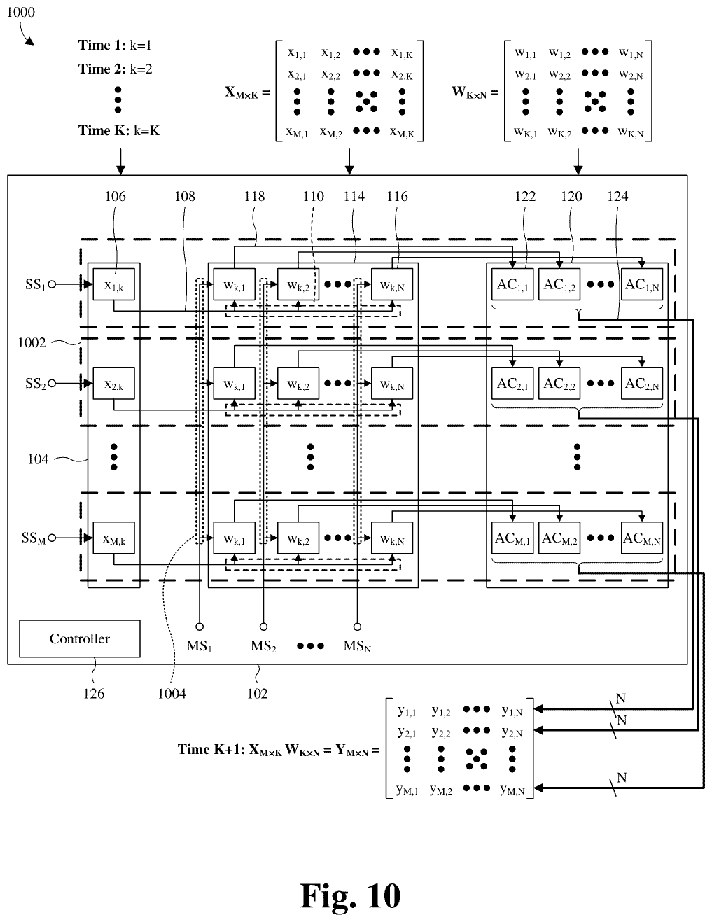

With reference to FIG. 10, a schematic diagram 1000 of some alternative embodiments of the photonic circuit 102 of FIG. 1 is provided in which the photonic circuit 102 is configured to concurrently performed M number of MAC operations, where M is an integer greater than 1. As seen hereafter, embodiments of the photonic circuit 102 in FIG. 1 are effectively replicated M times, and each replica performs one of the MAC operations. M may, for example, be 10, 100, 1000, 3840, 10000, or some other suitable value.

The M number of MAC operations are performed on an input matrix X_{M×K} of size M×K (e.g., M rows and K columns) and a weight matrix W_{K×N} of size K×N (e.g., K rows and N columns) to generate an output matrix Y_{M×N} of size M×N (e.g., M rows and N columns). Elements of the input matrix X_{M×K} are labeled x_{m,k}, elements of the weight matrix W_{K×N} are labeled w_{k,n}, and elements of the output matrix Y_{M×N} are labeled y_{m,n}. k is an integer index from 1 to K. n is an integer index from 1 to N. m is an integer index from 1 to M.

Each row of the input matrix X_{M×K} corresponds to an input row vector (see, e.g., the input row vector X_{1×K} of FIG. 1), and each row of the output matrix Y_{M×N} corresponds to an output row vector (see, e.g., the output row vector Y_{1×N} of FIG. 1). Further, each input row vector is multiplied with the weight matrix W_{K×N}, thereby performing one of the M number of MAC operations and thereby generating a corresponding output row vector.

The M number of MAC operations are performed respectively by M number of MAC blocks 1002. Each of the M number of MAC blocks 1002 is configured to perform a MAC operation between a corresponding input row vector of the input matrix X_{M×K} and the weight matrix W_{K×N} to generate a corresponding output row vector of the output matrix Y_{M×N}. The M number of MAC blocks 1002 are formed across the source 104, the modulator 114, and the detector 120. Further, the M number of MAC blocks 1002 perform MAC operations in the same manner described with regard to FIG. 1 and share common numbers of source, modulator, and detector pixels, which are the same as those of the photonic circuit 102 in FIG. 1.

The source 104 comprises a source pixel 106 at each of the M number of MAC blocks 1002, such that there are M source pixels. The M source pixels may, for example, be regarded as forming a source array. Each source pixel 106 is configured to generate a light beam 108 with an intensity modulated according to a corresponding one of M source signals SSₘ, where m is an index from 1 to M. Further, an optical fan-out structure 110 is configured to generate N copies 112 of each light beam 108. Note that for ease of illustration, the optical fan-out structure 110 is illustrated with multiple discrete segments. However, in at least some embodiments, the optical fan-out structure 110 is a continuous structure.

The modulator 114 comprises N modulator pixels 116 for each of the M number of MAC blocks 1002, such that the modulator 114 comprises M*N modulator pixels. The M*N modulator pixels may, for example, be regarded as forming a modulator array (e.g., with M rows and N columns). The N modulator pixels 116 for a MAC block are configured to transmit the N copies 112 for that MAC block to generate N transmitted light beams 118 for that MAC block. Further, the N modulator pixels 116 for a MAC block have individual transmissivities respectively modulated according to N modulator signals MSₙ, where n is an index from 1 to N.

The N modulator signals MSₙ are shared across the M number of MAC blocks 1002 via N electrical fan-out structures 1004. An electrical fan-out structure may, for example, be or comprise a conductive line and M conductive branches. The M conductive branches correspond to the M number of MAC blocks, and each conductive branch extends from the conductive line to a modulator pixel at a corresponding MAC block. Because a modulator pixel uses little to no current, sharing the N modulator signals MSₙ has high energy efficiency. In some embodiments, the M*N modulator pixels are arranged in M rows and N columns, where the M rows correspond to the M number of MAC blocks 1002. Further, in at least some of such embodiments, the modulator pixels in each column are electrically controlled via a common electrical fan-out structure, which carries a corresponding one of the N modulator signals MSₙ.

The detector 120 comprises N detector pixels 122 for each of the M number of MAC blocks 1002, such that the detector 120 comprises M*N detector pixels. The M*N detector pixels may, for example, be regarded as forming a detector array. The N detector pixels 122 for a MAC block are configured to accumulate charge respectively in response to the N transmitted light beams 118 for that MAC block and are labeled with individual accumulated charges AC_{m,n}. Further, the N detector pixels 122 for a MAC block are configured to convert the individual accumulated charges AC_{m,n} to N readout signals 124.

The controller 126 is shared amongst the M number of MAC blocks 1002 and is configured to coordinate the M number of MAC operations. At time 0 (e.g., immediately before the M number of MAC operations), the controller 126 is configured to reset the accumulated charges AC_{m,n} of the detector 120. From time 1 to time K, the controller 126 is configured to generate the M source signals SSₘ and the N modulator signals MSₙ in parallel using temporal multiplexing to perform the M number of MAC operations. At time K+1 (e.g., immediately after the M number of MAC operations), the controller 126 is configured to readout the individual accumulated charges AC_{m,n} to generate the output matrix Y_{M×N}.

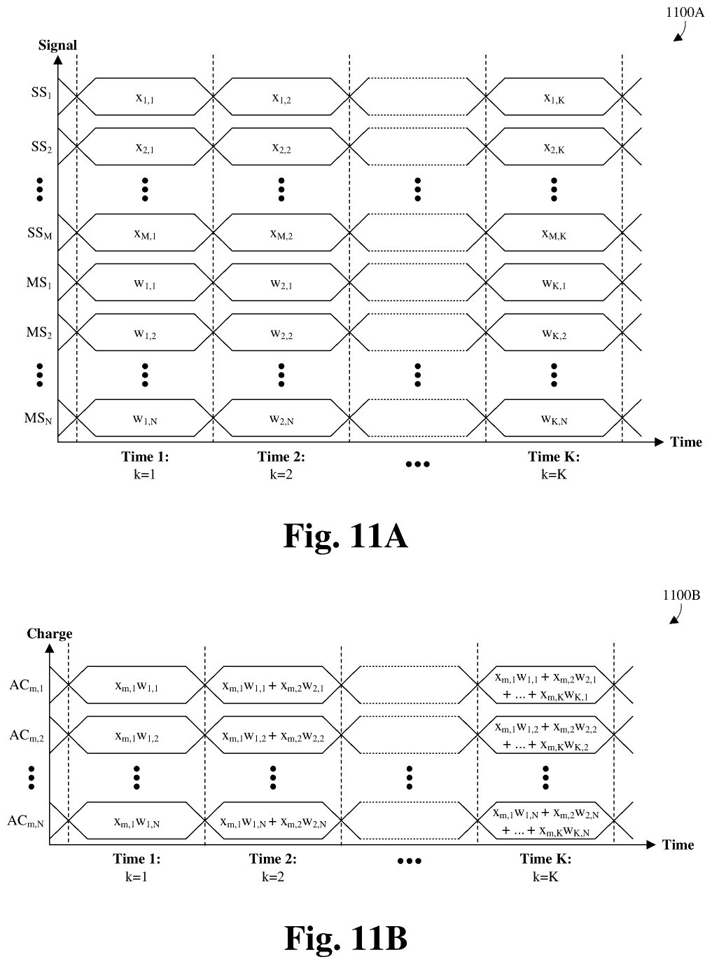

The M source signals SSₘ are generated by temporally encoding corresponding input row vectors of the input matrix X_{M×K}, such that each source signal modulates the intensity of a corresponding light beam 108 in accordance with values of an input row vector. FIG. 11A provides a signal timing diagram 1100A for some embodiments of the M source signals SSₘ. The N modulator signals MSₙ correspond to the columns of the weight matrix W_{K×N} and are each generated by temporally encoding a column vector of the weight matrix W_{K×N} at the corresponding column of the weight matrix W_{K×N}. As a result, each of the individual transmissivities of the modulator 114 is modulated in accordance with values of the weight matrix W_{K×N} at a corresponding column of the weight matrix W_{K×N}. FIG. 11A provides a signal timing diagram 1100A for some embodiments of the N modulator signals MSₙ.

As explained with regard to FIG. 1, modulating the M source signals SSₘ and the N modulator signals MSₙ as above performs photonic multiplication at the modulator 114. Further, photonic summation for products of the photonic multiplication occurs at the detector 120 via charge accumulation. FIG. 11B provides a timing diagram 1100B for some embodiments of individual accumulated charges AC_{m,n} of the detector 120 during the MAC operation. Note that within FIG. 11B, m represents an index from 1 to M for any MAC block.

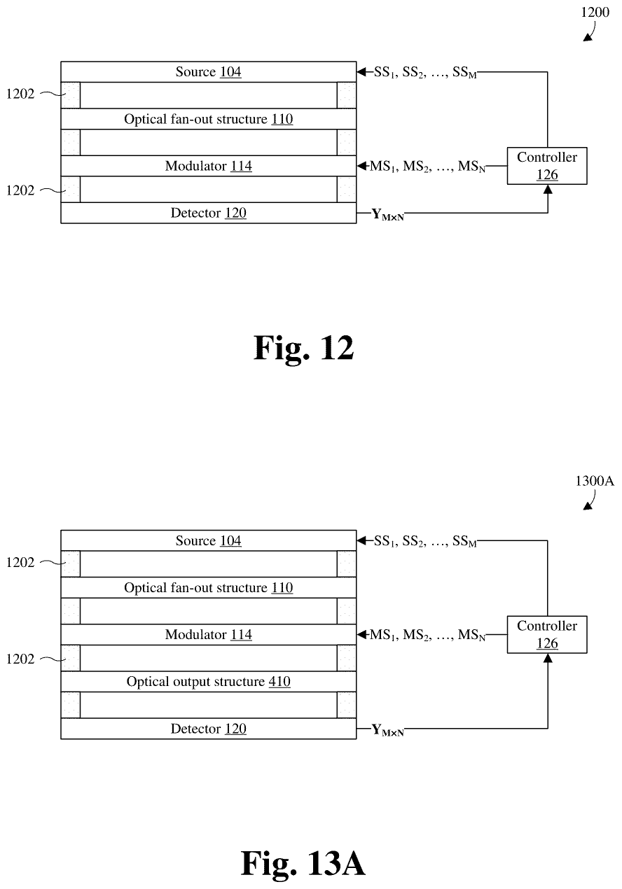

With reference to FIG. 12, a cross-sectional view 1200 of some embodiments of the photonic circuit 102 of FIG. 10 is provided. The source 104, the optical fan-out structure 110, the modulator 114, and the detector 120 are vertically stacked and are fixed to each other by a plurality of spacers 1202. The modulator 114 overlies and is fixed to the detector 120 by one or more first spacers of the plurality of spacers 1202. The optical fan-out structure 110 overlies and is fixed to the modulator 114 by one or more second spacers of the plurality of spacers 1202. The source 104 overlies and is fixed to the optical fan-out structure 110 by one or more third spacers of the plurality of spacers 1202. The controller 126 is separate from the stack.

In alternative embodiments, rather than being vertically stacked, the source 104, the optical fan-out structure 110, the modulator 114, and the detector 120 are laterally stacked. Further, in alternative embodiments, rather than being separate from the vertical stack, the controller 126 may be stacked with the source 104, the optical fan-out structure 110, the modulator 114, and the detector 120. For example, the controller 126 may underlie and be fixed to the detector 120 by one or more fourth spacers of the plurality of spacers 1202.

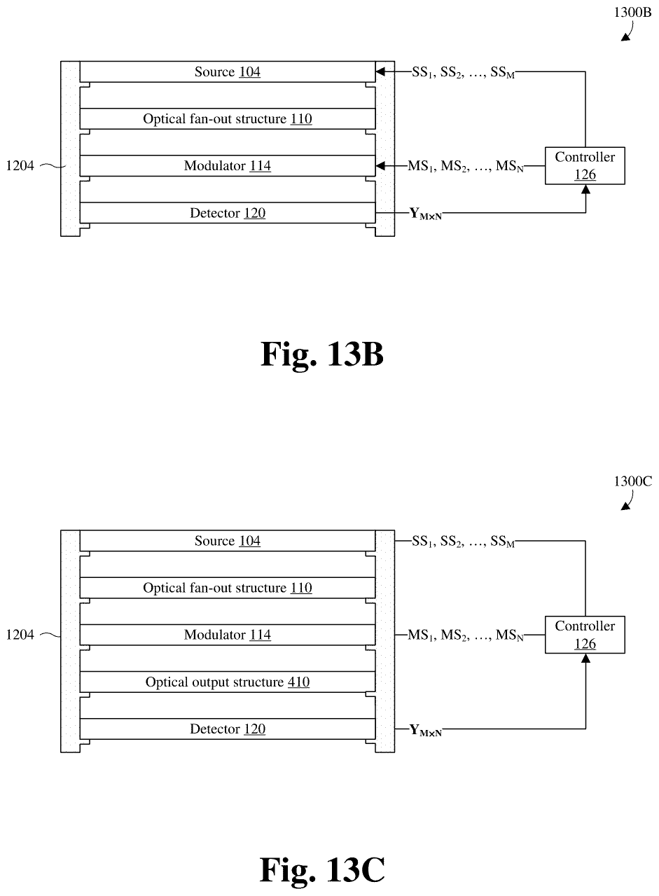

With reference to FIGS. 13A-13C, cross-sectional views 1300A-1300C of some alternative embodiments of the photonic circuit 102 of FIG. 12 are provided.

In FIG. 13A, the photonic circuit 102 further comprises the optical output structure 410. The optical output structure is between the modulator 114 and the detector 120. As described with regard to FIG. 4C, for example, the optical output structure 410 may be configured to focus N transmitted light beams respectively on N detector pixels.

In FIGS. 13B and 13C, the plurality of spacers 1202 are replaced with a rack 1204 to support the source 104, the optical fan-out structure 110, the modulator 114, and the detector 120. FIG. 13C has the optical output structure 410, whereas FIG. 13B does not.

While FIGS. 8, 9A, and 9B are described with regard to the photonic circuit of FIG. 1, it is to be appreciated that FIGS. 8, 9A, and 9B are applicable to any of FIGS. 10, 12, and 13A-13C. For example, each detector pixel of the detector 120 in any of FIGS. 10, 12, and 13A-13C may be as in FIG. 9A or 9B. Further, the controller 126 in any of FIGS. 10, 12, and 13A-13C may be as in FIG. 8, except that the input row vector X_{1×K} and the output row vector Y_{1×N} may be replaced with the input matrix X_{M×K} and the output matrix Y_{M×N}. Further, the source signal SS may be replaced with the M source signals SSₘ.

While FIGS. 12 and 13A-13C are described with regard to the photonic circuit of FIG. 10, it is to be appreciated that FIGS. 12 and 13A-13C are applicable to any of FIGS. 1, 3, 4A-4D, 6, and 7. For example, constituents in any of FIGS. 1, 3, 4A-4D, 6, and 7 may be vertically stacked using the plurality of spacers 1202 or the rack 1204.

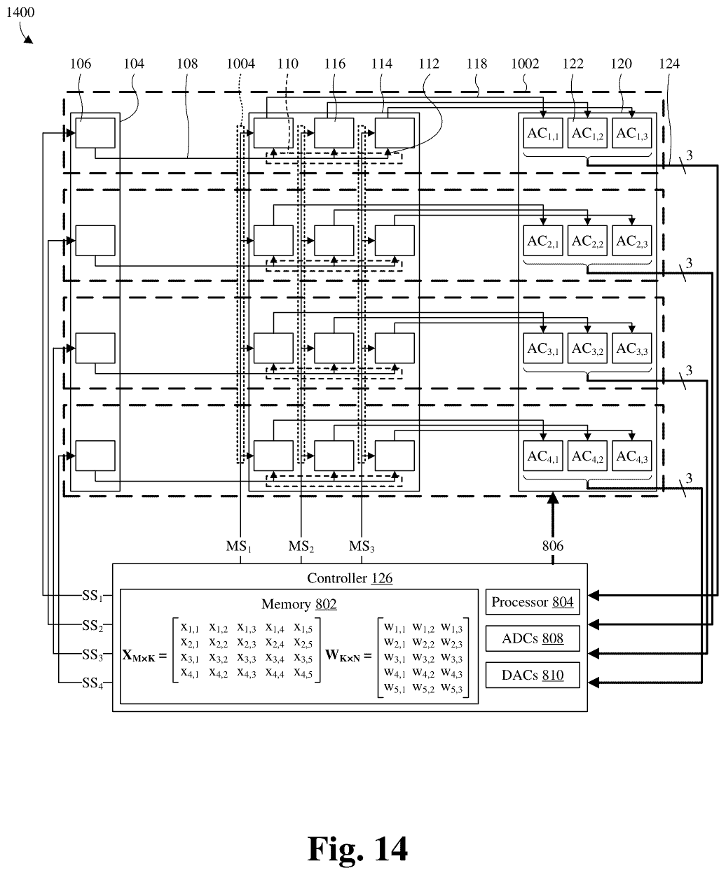

With reference to FIGS. 14-21, a series of schematic views 1400-2100 of some embodiments of a method for performing a plurality of MAC operations concurrently using temporal multiplexing is provided. The method is performed between an input matrix X_{M×K} and a weight matrix W_{K×N} to generate an output matrix Y_{M×N}, where M, N, and K are respectively 4, 3, and 5. Other suitable integer values are, however, amenable for any one or more of M, N, and K. The method may, for example, employ a photonic circuit similar to that of FIG. 10, whereby the timing diagrams at FIGS. 11A and 11B apply to the method.

As illustrated by the schematic view 1400 of FIG. 14, the photonic circuit is provided or otherwise formed. The photonic circuit comprises M number of MAC blocks 1002, which are electrically coupled to and controlled by a controller 126. As noted above, M is equal to 4. The controller 126 may, for example, comprise a memory 802, a processor 804, a plurality of ADCs 808, and a plurality of DACs 810. The processor 804 may, for example, coordinate the plurality of MAC operations through use of the memory 802 to store the input matrix X_{M×K} and the weight matrix W_{K×N}. The processor 804 may, for example, perform the coordination via circuitry and/or execution of processor-executable instructions on the memory 802.

The M number of MAC blocks 1002 are spread across a source 104, a modulator 114, and a detector 120. The source 104 comprises a source pixel 106 at each of the M number of MAC blocks 1002, such that there are M source pixels. Each source pixel 106 is configured to generate a light beam 108 with an intensity modulated according to a corresponding one of M source signals SSₘ, where m is an index from 1 to M. The M source signals SSₘ are generated by the controller 126 using, for example, the plurality of DACs 810. Further, an optical fan-out structure 110 is configured to generate N copies 112 of each light beam 108.

The modulator 114 comprises N modulator pixels 116 for each of the M number of MAC blocks 1002, such that the modulator 114 comprises M*N modulator pixels. As noted above, N is equal to 3. The N modulator pixels 116 for a MAC block are configured to transmit the N copies 112 for that MAC block to generate N transmitted light beams 118 for that MAC block. Further, the N modulator pixels 116 for a MAC block have individual transmissivities respectively modulated according to N modulator signals MSₙ, where n is an index from 1 to N. The N modulator signals MSₙ are shared by the M number of MAC blocks 1002 via N electrical fan-out structures 1004. Further, the N modulator signals MSₙ are generated by the controller 126 using, for example, the plurality of DACs 810.

The detector 120 comprises N detector pixels 122 for each of the M number of MAC blocks 1002, such that the detector 120 comprises M*N detector pixels. The N detector pixels 122 for a MAC block are configured to accumulate charge respectively in response to the N transmitted light beams 118 for that MAC block. Further, the N detector pixels 122 for a MAC block are configured to convert accumulated charge into N electrical signals for that MAC block, which may be read by the controller 126 using, for example, the plurality of ADCs 808.

As seen hereafter, charge accumulated at the N detector pixels 122 for a MAC block is schematically represented by labeling the N detector pixels 122 with accumulated charges AC_{m,n}. Further, charge accumulated at the N detector pixels 122 for a MAC block may, for example, be accumulated at individual photodetectors of the N detector pixels 122 or at individual capacitors of the N detector pixels 122.

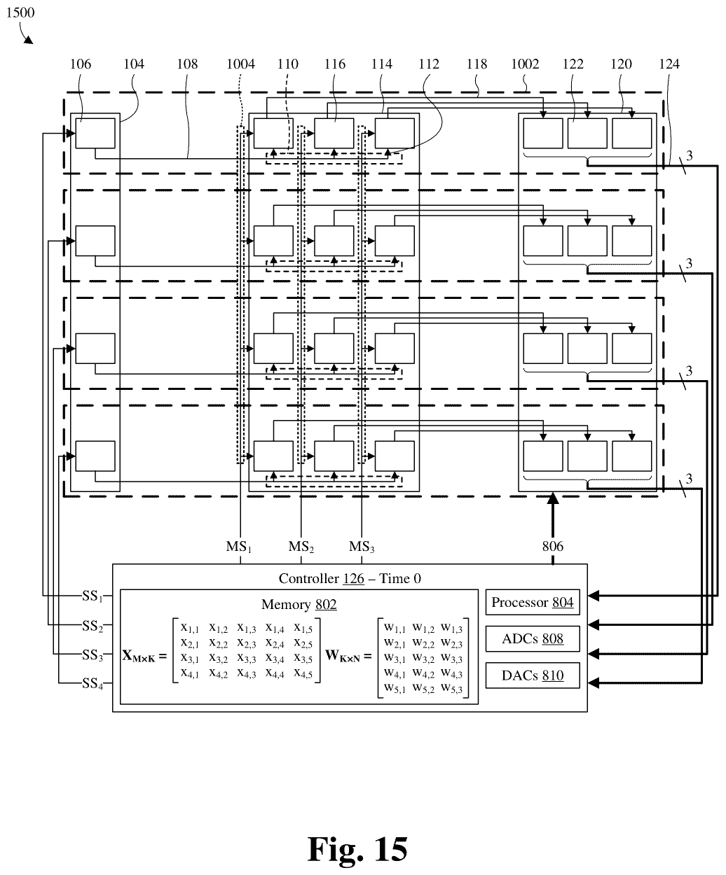

As illustrated by the schematic view 1500 of FIG. 15, at time 0, the controller 126 resets the detector 120 to clear the accumulated charges AC_{m,n}. For example, supposing detector pixels of the detector 120 are each as in FIG. 9A or 9B, the controller 126 may employ the plurality of DACs 810 to generate the detector control signals 806 with a reset control signal RST that clears the charge. The reset control signal RST may, for example, set a reset transistor (e.g., 906 of FIGS. 9A and 9B) to an ON state, thereby clearing accumulated charge.

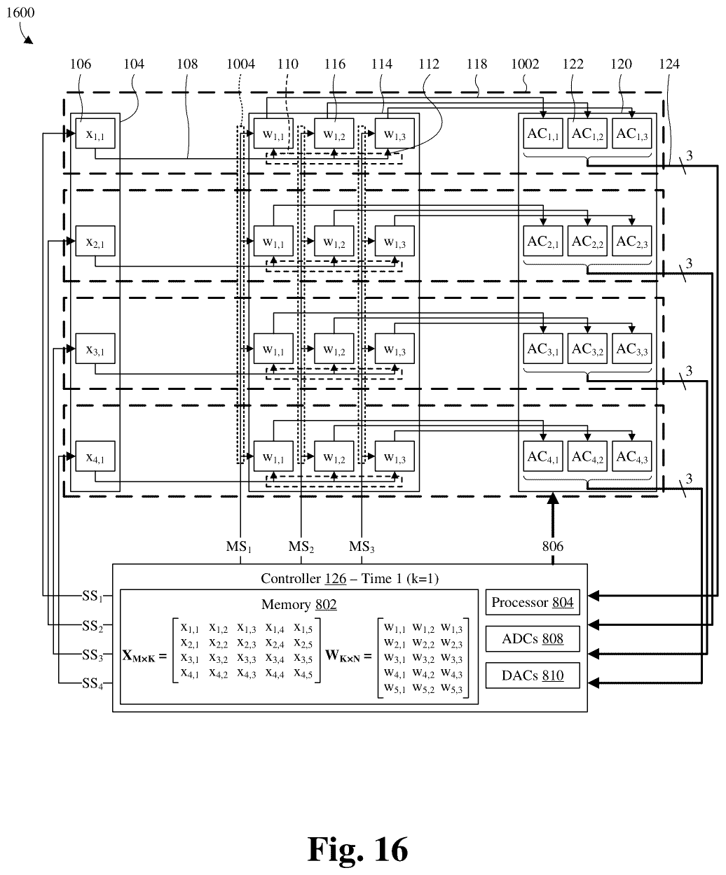

As illustrated by the schematic views 1600-2000 of FIG. 16-20, the controller 126 temporarily modulates the M source signals SSₘ and the N modulation signals MSₙ to perform the plurality of MAC operations. The plurality of MAC operations are performed over K time segments, which are of equal duration. As noted above, K is equal to 5 and corresponds to the number of columns of the input matrix X_{M×K} and the number of rows of the weight matrix W_{K×N}. The K time segments are indexed from 1 to K and are respectively referred to as time 1 to time K. Further, the K time segments are illustrated respectively by FIGS. 16-20.

Focusing on FIG. 16, the controller 126 generates the M source signals SSₘ and the N modulation signals MSₙ at time 1. At time 1, an index k has a value of 1, whereby the M source signals SSₘ and the N modulation signals MSₙ are generated according to values of the input matrix X_{M×K} with k=1 and values of the weight matrix W_{K×N} with k=1.

The M source signals SSₘ are respectively generated according to values of the input matrix X_{M×K} in the first column of the input matrix X_{M×K} so the light beam 108 at each of MAC blocks has an intensity encoding a corresponding one the values. This is schematically illustrated by labeling the M source pixels with the values of the input matrix X_{M×K}. The N modulator signals MSₙ are respectively generated according to values of the weight matrix W_{K×N} in the first row of the weight matrix W_{K×N} so the N modulator pixels 116 at each MAC block have individual transmissivities respectively encoding the values. This is schematically illustrated by labeling the N modulator pixels 116 at each MAC block with the values.

Focusing on a MAC block (e.g., any one of the M number of MAC blocks 1002), the N copies 112 of the light beam 108 at the MAC block are transmitted through the N modulator pixels 116 of the MAC block, which leads to photonic multiplication. Because individual transmissivities of the N modulator pixels 116 encode the first row of the weight matrix W_{K×N}, and because an intensity of the N copies 112 encodes a value in a first column of the input matrix X_{M×K}, the photonic multiplication is between this value and the first row of the weight matrix W_{K×N}. Further, products of the photonic multiplication are represented respectively by individual intensities of the N transmitted light beams 118 of the MAC block.

Continuing to focus on the MAC block, the N transmitted light beams 118 of the MAC block impinge respectively on the N detector pixels 122 of the MAC block. This causes charge to accumulate at the N detector pixels 122, which is proportional to the products of photonic multiplication. Hence, the N detector pixels 122 are labeled with accumulate charges AC_{m,n}. In some embodiments, each of the accumulated charges AC_{m,n} is equal to or otherwise represents x_{m,1}*w_{1,n} (e.g., a product of multiplication).

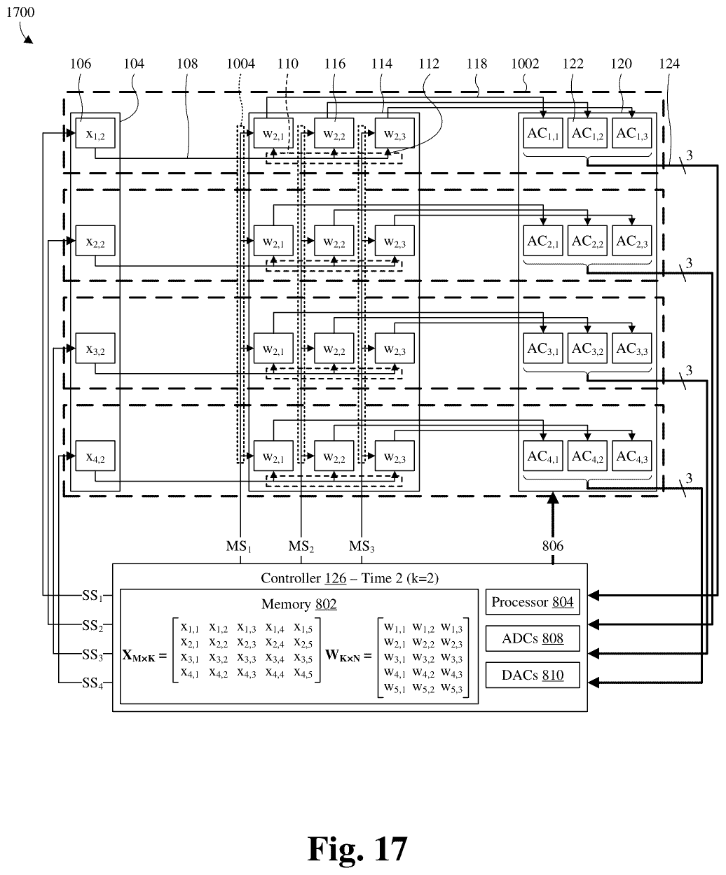

Focusing on FIG. 17, the controller 126 generates the M source signals SSₘ and the N modulation signals MSₙ at time 2. At time 2, k has a value of 2, whereby the M source signals SSₘ and the N modulation signals MSₙ are generated according to values of the input matrix X_{M×K} with k=2 and values of the weight matrix W_{K×N} with k=2.

Focusing on a MAC block (e.g., any one of the M number of MAC blocks 1002), the photonic multiplication at the N modulator pixels 116 of the MAC block is between the second row of the weight matrix W_{K×N} and a value in a second column of the input matrix X_{M×K}. Further, additional charge accumulates at the N detector pixels 122 of the MAC block, which is proportional to the products of the photonic multiplication. In some embodiments, each of the accumulated charges AC_{m,n} is equal to or otherwise represents x_{m,1}*w_{1,n}+x_{m,2}*w_{2,n}.

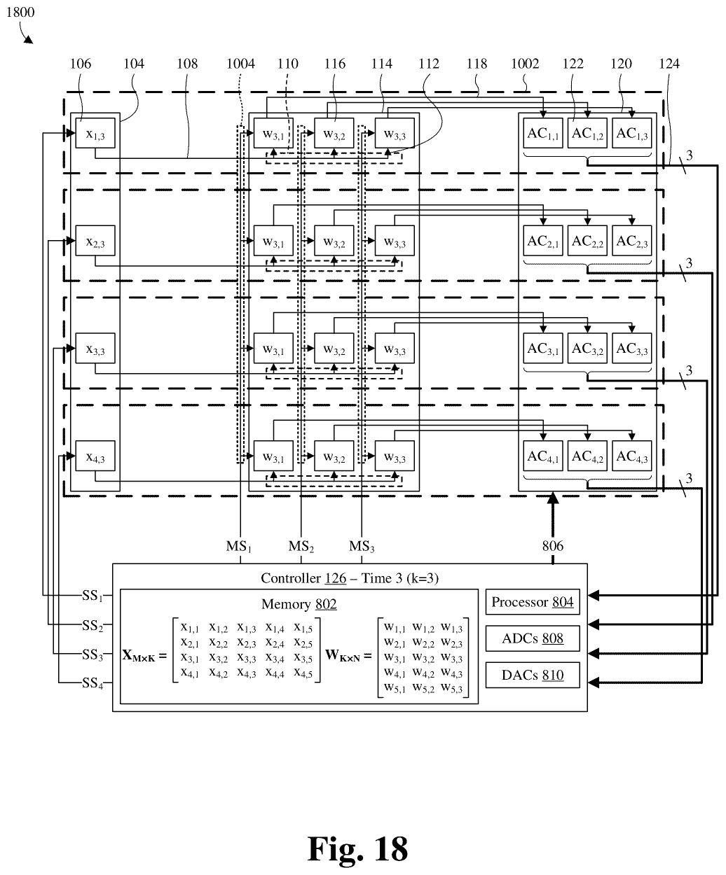

Focusing on FIG. 18, the controller 126 generates the M source signals SSₘ and the N modulation signals MSₙ at time 3. At time 3, k has a value of 3, whereby the M source signals SSₘ and the N modulation signals MSₙ are generated according to values of the input matrix X_{M×K} with k=3 and values of the weight matrix W_{K×N} with k=3.

Focusing on a MAC block (e.g., any one of the M number of MAC blocks 1002), the photonic multiplication at the N modulator pixels 116 of the MAC block is between the third row of the weight matrix W_{K×N} and a value in a third column of the input matrix X_{M×K}. Further, additional charge accumulates at the N detector pixels 122 of the MAC block, which is proportional to the products of the photonic multiplication. In some embodiments, each of the accumulated charges AC_{m,n} is equal to or otherwise represents x_{m,1}*w_{1,n}+x_{m,2}*w_{2,n}+x_{m,3}*w_{3,n}.

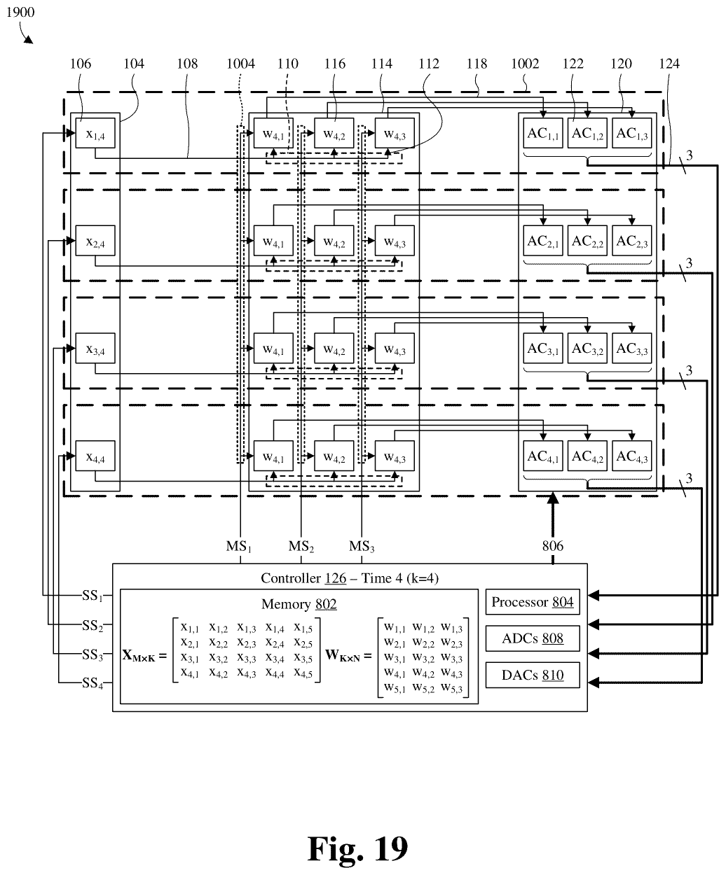

Focusing on FIG. 19, the controller 126 generates the M source signals SSₘ and the N modulation signals MSₙ at time 4. At time 4, k has a value of 4, whereby the M source signals SSₘ and the N modulation signals MSₙ are generated according to values of the input matrix X_{M×K} with k=4 and values of the weight matrix W_{K×N} with k=4.

Focusing on a MAC block (e.g., any one of the M number of MAC blocks 1002), the photonic multiplication at the N modulator pixels 116 of the MAC block is between the fourth row of the weight matrix W_{K×N} and a value in a fourth column of the input matrix X_{M×K}. Further, additional charge accumulates at the N detector pixels 122 of the MAC block, which is proportional to the products of the photonic multiplication. In some embodiments, each of the accumulated charges AC_{m,n} is equal to or otherwise represents x_{m,1}*w_{1,n}+x_{m,2}*w_{2,n}+x_{m,3}*w_{3,n}+x_{m,4}*w_{4,n}.

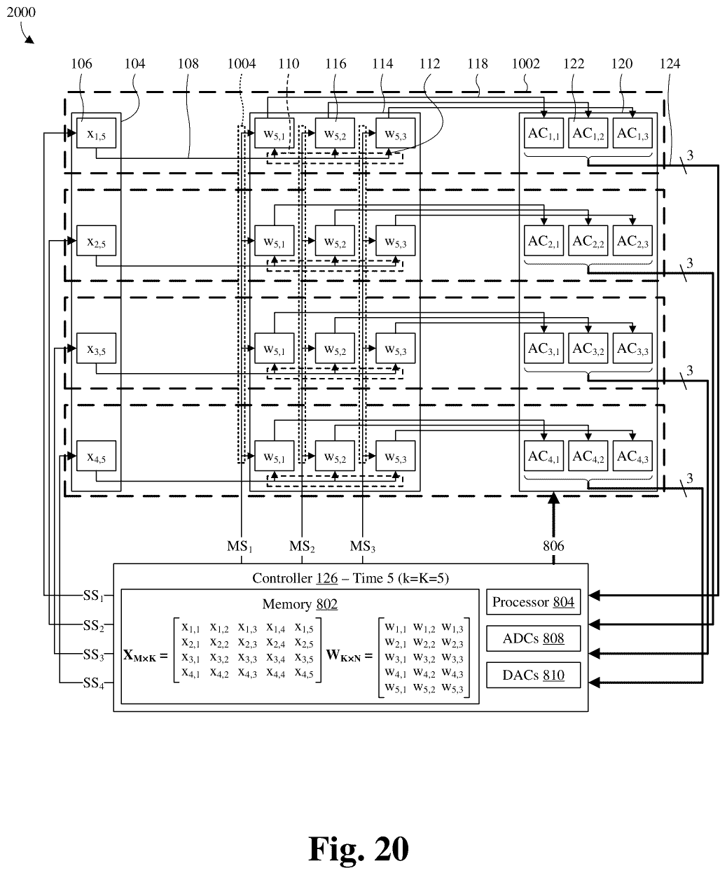

Focusing on FIG. 20, the controller 126 generates the M source signals SSₘ and the N modulation signals MSₙ at time 5. At time 5, k has a value of 5, whereby the M source signals SSₘ and the N modulation signals MSₙ are generated according to values of the input matrix X_{M×K} with k=5 and values of the weight matrix W_{K×N} with k=5.

Focusing on a MAC block (e.g., any one of the M number of MAC blocks 1002), the photonic multiplication at the N modulator pixels 116 of the MAC block is between the fifth row of the weight matrix W_{K×N} and a value in a fifth column of the input matrix X_{M×K}. Further, additional charge accumulates at the N detector pixels 122 of the MAC block, which is proportional to the products of the photonic multiplication. In some embodiments, each of the accumulated charges AC_{m,n} is equal to or otherwise represents x_{m,1}*w_{1,n}+x_{m,2}*w_{2,n}+x_{m,3}*w_{3,n}+x_{m,4}*w_{4,n}+x_{m,5}*w_{5,n}. Further, in some embodiments, the charge accumulation at each of the K time segments may more generally be written as AC_{m,n}=Σᵢ₌₁^{k} x_{m,i}w_{i,n}.

Because the input matrix X_{M×K} is temporally encoded via light-beam intensity, the photonic circuit depends on only a single source pixel per MAC operation. Further, because column vectors of the weight matrix W_{K×N} are temporally encoded via modulator-pixel transmissivity, the photonic circuit depends on only N modulator pixels per MAC operation. Hence, K is decoupled from the numbers of source and modulator pixels. Further, K is effectively unlimited, limited only by time, and may hence be large.

Because K may be large, high accuracy modeling may be achieved when the photonic circuit is employed to perform MAC operations for DNN algorithms or other suitable AI/ML algorithms. Further, because K may be large, the source pixels may be driven at a low power level to perform MAC operations with high power efficiency. The low power level may, for example, be a power level of less than 10 photons, 1 photon, less than 1 photon (on average), or some other suitable level per photonic multiplication.

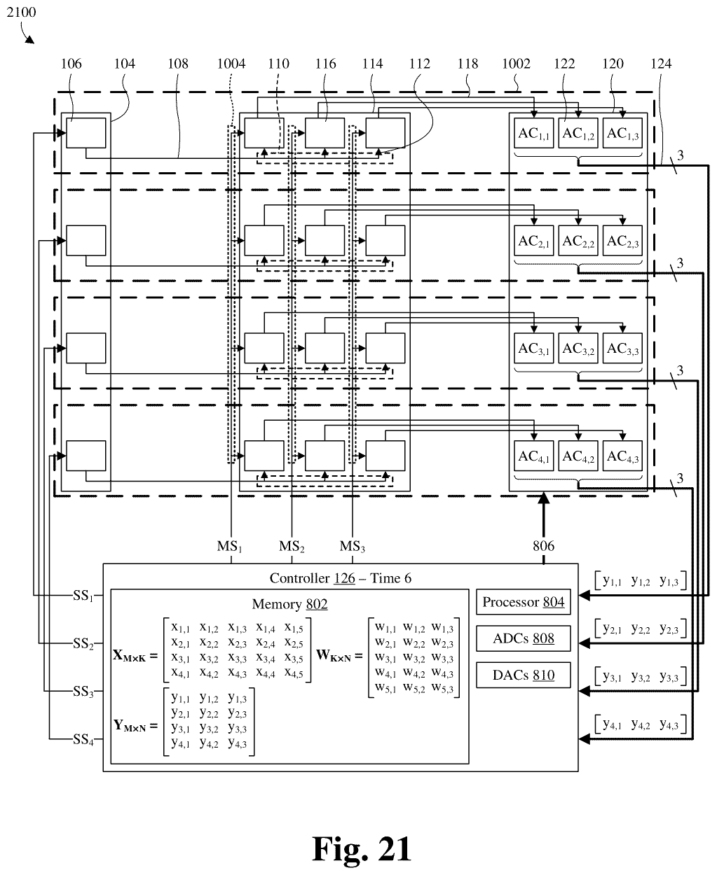

As illustrated by the schematic view 2100 of FIG. 21, at time 6, the controller 126 generates the output matrix Y_{M×N} from the accumulated charges AC_{m,n}. For example, the controller 126 may employ the plurality of DACs 810 to generate the detector control signals 806 so the N detector pixels 122 at each MAC block convert accumulated charges to the N readout signals 124 for that MAC block. The controller 126 may then read the N readout signals 124 for that MAC block (e.g., using the plurality of ADCs 808) and may generate a corresponding row vector of the output matrix Y_{M×N} from the N readout signals 124.

While FIGS. 14-21 are described with reference to a method, it will be appreciated that the structures shown in these figures are not limited to the method but rather may stand alone separate from the method. While FIGS. 14-21 are described as a series of acts, it will be appreciated that the order of the acts may be altered in other embodiments. While FIGS. 14-21 illustrate and describe as a specific set of acts, some acts that are illustrated and/or described may be omitted in other embodiments. Further, acts that are not illustrated and/or described may be included in other embodiments.

Further, while not illustrated, the method may be performed multiple times in series. For example, the method may be performed at each layer of an optical neural network (ONN) or DNN, while traversing the ONN or DNN. In such embodiments, the output matrix Y_{M×N} at each performance of the method is used as the input matrix X_{M×K} for a next performance of the method, which uses a different weight matrix W_{K×N}. For example, the method may be run using a first input matrix X1 and a first weight matrix W1 to generate a first output matrix Y1. Then, the method may be run again using a second input matrix X2 and a second weight matrix W2 to generate a second output matrix Y2, wherein the second input matrix X2 equals the first output matrix Y1. Then, the method may be run again using a third input matrix X3 and a third weight matrix W3 to generate a third output matrix Y3, wherein the third input matrix X3 equals the second output matrix Y2. This may continue zero or more times.

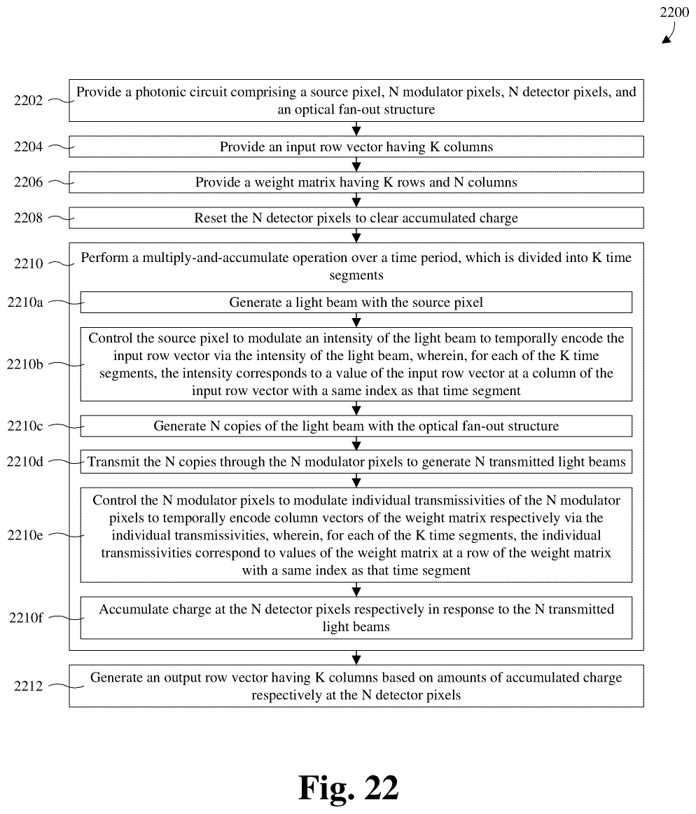

With reference to FIG. 22, a block diagram 2200 of some embodiments of the method of FIGS. 14-21 is provided.

At act 2202, a photonic circuit comprising a source pixel, N modulator pixels, N detector pixels, and an optical fan-out structure is provided. See, for example, FIG. 14.

At act 2204, an input row vector having K columns is provided. See, for example, FIG. 14.

At act 2206, a weight matrix having K rows and N columns is provided. See, for example, FIG. 14.

At act 2208, the N detector pixels are reset to clear accumulated charge. See, for example, FIG. 15.

At act 2210, a MAC operation is performed over a time period, which is divided into K time segments. See, for example, FIGS. 16-20. At act 2210a, a light beam is generated with the source pixel. At act 2210b, the source pixel is controlled to modulate an intensity of the light beam to temporally encode the input row vector via the intensity of the light beam, wherein, for each of the K time segments, the intensity corresponds to a value of the input row vector at a column of the input row vector with a same index as that time segment. At act 2210c, N copies of the light beam are generated with the optical fan-out structure. At act 2210d, the N copies are transmitted through the N modulator pixels to generate N transmitted light beams. At act 2210e, the N modulator pixels are controlled to modulate individual transmissivities of the N modulator pixels to temporally encode column vectors of the weight matrix respectively via the individual transmissivities, wherein, for each of the K time segments, the individual transmissivities correspond to values of the weight matrix at a row of the weight matrix with a same index as that time segment. At act 2210f, charge is accumulated at the N detector pixels respectively in response to the N transmitted light beams.

At act 2212, an output row vector having K columns is generated based on amounts of accumulated charge respectively at the N detector pixels. See, for example, FIG. 21.

While the block diagram 2200 of FIG. 22 is illustrated and described herein as a series of acts or events, it will be appreciated that the illustrated ordering of such acts or events is not to be interpreted in a limiting sense. For example, some acts may occur in different orders and/or concurrently with other acts or events apart from those illustrated and/or described herein. Further, not all illustrated acts may be required to implement one or more aspects or embodiments of the description herein, and one or more of the acts depicted herein may be carried out in one or more separate acts and/or phases.

In some embodiments, the present disclosure provides a photonic circuit, including: a source configured to generate a light beam; an optical fan-out structure optically coupled to the source and configured to generate a plurality of copies of the light beam; a modulator optically coupled to the optical fan-out structure and configured to transmit the plurality of copies of the light beam with individual transmissivities to generate a plurality of transmitted light beams; a plurality of detector pixels optically coupled respectively to the modulator and configured to accumulate charge respectively in response to the plurality of transmitted light beams; and a controller configured to control the source to modulate an intensity of the light beam, and to control the modulator to modulate the individual transmissivities, to perform a vector-matrix multiplication operation between an input row vector and a weight matrix. In some embodiments, the controller is configured to control the source to temporally encode the input row vector via the intensity of the light beam during the vector-matrix multiplication operation. In some embodiments, the individual transmissivities correspond to column vectors of the weight matrix, wherein the controller is configured to control the modulator to temporally encode each of the column vectors via a corresponding one of the individual transmissivities during the vector-matrix multiplication operation. In some embodiments, the controller is configured to: perform the vector-matrix multiplication operation over a time period, which is divided into K time segments; control the intensity according to a value at a column of the input row vector with a same index as a current time segment of the K time segments; and control the individual transmissivities according to values of the weight matrix, respectively, at a row of the weight matrix with a same index as the current time segment. In some embodiments, the source includes a light-emitting diode or a vertical-cavity surface-emitting laser. In some embodiments, the optical fan-out structure includes a DOE and a 4f optical system. In some embodiments, the plurality of detector pixels include individual photodetectors and individual capacitors electrically and respectively coupled to the individual photodetectors.

In some embodiments, the present disclosure provides another a photonic circuit, including: a plurality of modulator pixels configured to transmit a plurality of light beams, respectively, with individual transmissivities to generate a plurality of transmitted light beams; a plurality of detector pixels including individual photodetectors optically coupled respectively to outputs of the plurality of modulator pixels; and a controller configured to perform a first vector-matrix multiplication operation between an input row vector of size K and a weight matrix of size K×N, wherein the first vector-matrix multiplication operation includes: setting the individual transmissivities according to values of the weight matrix in a first row of the weight matrix, respectively, for a first time period; and setting the individual transmissivities according to values in a second row of the weight matrix, respectively, for a second time period. In some embodiments, the photonic circuit further includes: a source pixel configured to generate a source light beam; and an optical fan-out structure configured to generate a plurality of copies of the source light beam, wherein the plurality of copies correspond to the plurality of light beams, and wherein the first vector-matrix multiplication operation includes: setting an intensity of the source light beam according to a value of the input row vector at a first column of the input row vector for the first time period; and setting the intensity of the source light beam according to a value of the input row vector at a second column of the input row vector for the second time period. In some embodiments, the photonic circuit further includes a plurality of source pixels configured to generate the plurality of light beams. In some embodiments, the first vector-matrix multiplication operation includes, for each row of the weight matrix, setting the individual transmissivities according to values in that row, respectively, wherein the first vector-matrix multiplication operation uses only N of the plurality of modulator pixels concurrently. In some embodiments, the first vector-matrix multiplication operation uses only N of the plurality of detector pixels concurrently. In some embodiments, the photonic circuit further includes an additional plurality of modulator pixels; and a plurality of electrical fan-out structures, each electrically coupled to one of the plurality of modulator pixels and one of the additional plurality of modulator pixels; wherein the controller is configured to set individual transmissivities of the additional plurality of modulator pixels respectively in parallel with the individual transmissivities of the plurality of modulator pixels via the plurality of electrical fan-out structures. In some embodiments, the controller is configured to perform a second vector-matrix multiplication operation between an additional input vector of size K and the weight matrix, wherein the second vector-matrix multiplication operation is performed in parallel with the first vector-matrix multiplication operation using the additional plurality of modulator pixels.

In some embodiments, the present disclosure provides a method, including: providing an input row vector and a weight matrix; multiplying the input row vector and the weight matrix together over a time period, wherein the multiplying includes: generating a plurality of light beams sharing an intensity, which varies over the time period between intensity values that correspond to values of the input row vector; transmitting the plurality of light beams respectively through a plurality of modulator pixels to respectively generate a plurality of transmitted light beams, wherein the plurality of modulator pixels have individual transmissivities varying over the time period between transmissivity values that correspond to values of the weight matrix; and accumulating charge at a plurality of detector pixels over the time period in response to the transmitted light beams impinging respectively on the plurality of detector pixels. In some embodiments, the individual transmissivities each correspond to a column of the weight matrix and vary over the time period between transmissivity values that correspond to values of the weight matrix in the corresponding column. In some embodiments, the multiplying includes: generating an output row vector equal to a product of the input row vector and the weight matrix based at completion of the time period, wherein values of the output row vector correspond to amounts of accumulated charge respectively at the plurality of detector pixels at completion of the time period. In some embodiments, the multiplying is performed using a total number of modulator pixels and a total number of detector pixels both equal to a total number of columns in the weight matrix. In some embodiments, the time period is divided into a K time segments indexed from 1 to K, wherein the intensity corresponds to a value of the input row vector at a column of the input row vector with a same index as a current one of the K time segments, and wherein the individual transmissivities correspond to values of the weight matrix at a row of the weight matrix with a same index as the current one of the K time segments. In some embodiments, the generating of the plurality of light beams includes: generating a source light beam with the intensity; and optically copying the source light beam, wherein copies of the source light beam correspond to the plurality of the light beams.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A photonic circuit, comprising:
a source configured to generate a light beam;
an optical fan-out structure optically coupled to the source and configured to generate a plurality of copies of the light beam;
a modulator optically coupled to the optical fan-out structure and configured to transmit the plurality of copies of the light beam with individual transmissivities to generate a plurality of transmitted light beams;
a plurality of detector pixels optically coupled respectively to the modulator and configured to accumulate charge respectively in response to the plurality of transmitted light beams; and
a controller configured to control the source to modulate an intensity of the light beam, and to control the modulator to modulate the individual transmissivities, to perform a vector-matrix multiplication operation between an input row vector and a weight matrix.

2. The photonic circuit according to claim 1, wherein the controller is configured to control the source to temporally encode the input row vector via the intensity of the light beam during the vector-matrix multiplication operation.

3. The photonic circuit according to claim 1, wherein the individual transmissivities correspond to column vectors of the weight matrix, and wherein the controller is configured to control the modulator to temporally encode each of the column vectors via a corresponding one of the individual transmissivities during the vector-matrix multiplication operation.

4. The photonic circuit according to claim 1, wherein the controller is configured to:
perform the vector-matrix multiplication operation over a time period, which is divided into K time segments;
control the intensity according to a value at a column of the input row vector with a same index as a current time segment of the K time segments; and
control the individual transmissivities according to values of the weight matrix, respectively, at a row of the weight matrix with a same index as the current time segment.

5. The photonic circuit according to claim 1, wherein the source comprises a light-emitting diode or a vertical-cavity surface-emitting laser.

6. The photonic circuit according to claim 1, wherein the optical fan-out structure comprises a diffractive optical element (DOE) and a 4f optical system.

7. The photonic circuit according to claim 1, wherein the plurality of detector pixels comprise individual photodetectors and individual capacitors electrically and respectively coupled to the individual photodetectors.

8. A photonic circuit, comprising:
a plurality of modulator pixels configured to transmit a plurality of light beams, respectively, with individual transmissivities to generate a plurality of transmitted light beams;
a plurality of detector pixels comprising individual photodetectors optically coupled respectively to outputs of the plurality of modulator pixels; and
a controller configured to perform a first vector-matrix multiplication operation between an input row vector of size K and a weight matrix of size K×N, wherein the first vector-matrix multiplication operation comprises:
setting the individual transmissivities according to values of the weight matrix in a first row of the weight matrix, respectively, for a first time period; and
setting the individual transmissivities according to values in a second row of the weight matrix, respectively, for a second time period.

9. The photonic circuit according to claim 8, further comprising:
a source pixel configured to generate a source light beam; and
an optical fan-out structure configured to generate a plurality of copies of the source light beam, wherein the plurality of copies correspond to the plurality of light beams, and wherein the first vector-matrix multiplication operation comprises:
setting an intensity of the source light beam according to a value of the input row vector at a first column of the input row vector for the first time period; and
setting the intensity of the source light beam according to a value of the input row vector at a second column of the input row vector for the second time period.

10. The photonic circuit according to claim 8, further comprising:
a plurality of source pixels configured to generate the plurality of light beams.

11. The photonic circuit according to claim 8, wherein the first vector-matrix multiplication operation comprises, for each row of the weight matrix, setting the individual transmissivities according to values in that row, respectively, and wherein the first vector-matrix multiplication operation uses only N of the plurality of modulator pixels concurrently.

12. The photonic circuit according to claim 8, wherein the first vector-matrix multiplication operation uses only N of the plurality of detector pixels concurrently.

13. The photonic circuit according to claim 8, further comprising:
an additional plurality of modulator pixels; and
a plurality of electrical fan-out structures, each electrically coupled to one of the plurality of modulator pixels and one of the additional plurality of modulator pixels;
wherein the controller is configured to set individual transmissivities of the additional plurality of modulator pixels respectively in parallel with the individual transmissivities of the plurality of modulator pixels via the plurality of electrical fan-out structures.

14. The photonic circuit according to claim 13, wherein the controller is configured to perform a second vector-matrix multiplication operation between an additional input vector of size K and the weight matrix, and wherein the second vector-matrix multiplication operation is performed in parallel with the first vector-matrix multiplication operation using the additional plurality of modulator pixels.

15. A method, comprising:
providing an input row vector and a weight matrix;
multiplying the input row vector and the weight matrix together over a time period, wherein the multiplying comprises:
generating a plurality of light beams sharing an intensity, which varies over the time period between intensity values that correspond to values of the input row vector;
transmitting the plurality of light beams respectively through a plurality of modulator pixels to respectively generate a plurality of transmitted light beams, wherein the plurality of modulator pixels have individual transmissivities varying over the time period between transmissivity values that correspond to values of the weight matrix; and
accumulating charge at a plurality of detector pixels over the time period in response to the transmitted light beams impinging respectively on the plurality of detector pixels.

16. The method according to claim 15, wherein the individual transmissivities each correspond to a column of the weight matrix and vary over the time period between transmissivity values that correspond to values of the weight matrix in the corresponding column.

17. The method according to claim 15, wherein the multiplying comprises:
generating an output row vector equal to a product of the input row vector and the weight matrix based at completion of the time period, wherein values of the output row vector correspond to amounts of accumulated charge respectively at the plurality of detector pixels at completion of the time period.

18. The method according to claim 15, wherein the multiplying is performed using a total number of modulator pixels and a total number of detector pixels both equal to a total number of columns in the weight matrix.

19. The method according to claim 15, wherein the time period is divided into a K time segments indexed from 1 to K, wherein the intensity corresponds to a value of the input row vector at a column of the input row vector with a same index as a current one of the K time segments, and wherein the individual transmissivities correspond to values of the weight matrix at a row of the weight matrix with a same index as the current one of the K time segments.

20. The method according to claim 15, wherein the generating of the plurality of light beams comprises:
generating a source light beam with the intensity; and
optically copying the source light beam, wherein copies of the source light beam correspond to the plurality of the light beams.
